(19) United States
(12) Patent Application Publication
(10) Pub. No.: US 2013/0120485 A1
(43) Pub. Date: May 16, 2013

(54) LIQUID APPLICATION DEVICE, LIQUID APPLICATION METHOD, AND NANOIMPRINT SYSTEM

(71) Applicant: FUJIFILM CORPORATION, Tokyo (JP)

(72) Inventors: Kenichi Kodama, Kanagawa (JP); Tadashi Omatsu, Kanagawa (JP); Satoshi Wakamatsu, Kanagawa (JP); Kunihiko Kodama, Shizuoka (JP)

(73) Assignee: FUJIFILM CORPORATION, Tokyo (JP)

(21) Appl. No.: 13/730,476

(22) Filed: Dec. 28, 2012

Related U.S. Application Data
(63) Continuation of application No. PCT/JP2011/064626, filed on Jun. 27, 2011.

(30) Foreign Application Priority Data
Jun. 30, 2010 (JP) 2010-150366

(51) Int. Cl. B41J 2/045

(52) U.S. Cl. CPC B41J 2/04573
USPC 347/14

(57) ABSTRACT

A liquid application device includes: a liquid ejection head including: nozzles configured to perform ejection of droplets of liquid toward a substrate; and liquid chambers connected respectively to the nozzles and defined by side walls, at least respective parts of the side walls being constituted of piezoelectric elements, the liquid ejection head being configured to cause shear deformation of the piezoelectric elements to eject the droplets of the liquid in the liquid chamber through the nozzles; and a droplet ejection control device configured to group the nozzles into groups of not less than three in such a manner that adjacent nozzles belong to different groups, and is configured to control operation of the piezoelectric elements in such a manner that the droplet ejection is performed at a same timing only through the nozzles belonging to a same group so as to deposit the liquid discretely onto the substrate.

### TECHNICAL FIELD

The present invention relates to a liquid application device, a liquid application method and a nanoimprint system, and more particularly to liquid deposition technology for depositing liquid having functional properties onto a medium, such as a substrate, by an inkjet method.

### BACKGROUND ART

With the development of increasingly fine semiconductor integrated circuits and higher levels of integration in recent years, nanoimprint lithography (NIL) is known as technology for forming a fine structure on a substrate, in which a fine pattern formed on a stamper is transferred by applying a resist (ultraviolet (UV)-curable resin) onto a substrate, curing the resist by irradiation of ultraviolet light in a state where the stamper formed with the desired projection-recess pattern to be transferred is pressed against the resist, and separating the stamper from the resist on the substrate.

Patent Literatures 1 and 2 (PTLs 1 and 2) disclose systems for depositing liquid of imprint material onto substrates by means of an inkjet method. PTLs 1 and 2 disclose that these systems optimize the droplet deposition amount by changing the droplet deposition density and the droplet ejection volume in accordance with a pattern and an amount of evaporation of the imprint material (resist) when applying a prescribed amount of liquid onto a substrate, and thereby improving the throughput and uniformizing the thickness of the resist applied on the substrate.

### SUMMARY OF INVENTION

### Technical Problem

However, PTLs 1 and 2 only disclose algorithms relating to what kind of droplet deposition arrangement is desirable, and do not disclose specific compositions, such as hardware for achieving ideal droplet deposition density or droplet ejection volume.

The present invention has been contrived in view of these circumstances, an object thereof being to provide a liquid application device, a liquid application method and a nanoimprint system whereby deposition of droplets of functional liquid onto a substrate by an inkjet method is optimized and a desirable fine pattern can be formed.

### Solution to Problem

In order to attain the aforementioned object, a liquid application device according to a first aspect of the present invention comprises: a liquid ejection head including: a plurality of nozzles configured to perform ejection of droplets of liquid having functional properties toward a substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles; a relative movement device which is configured to cause relative movement of the substrate and the liquid ejection head; and a droplet ejection control device which is configured to group the nozzles in the liquid ejection head into groups of not less than three in such a manner that adjacent nozzles belong to different groups, and is configured to control operation of the piezoelectric elements in such a manner that the droplet ejection is performed at a same timing only through the nozzles belonging to a same group so as to deposit the liquid discretely onto the substrate.

According to this aspect, in the liquid application device including the liquid ejection head which ejects droplets of the liquid from the nozzles by causing shear deformation of the piezoelectric elements each of which constitutes at least a part of each of the side walls of the liquid chambers connected respectively to the nozzles, since the nozzles are grouped in such a manner that adjacent nozzles belong to different groups, and the droplet ejection is performed only from the nozzles belonging to the same group at the same droplet ejection timing, then droplet ejection is never performed from adjacent nozzles at the same droplet ejection timing, cross-talk produced by droplet ejection from adjacent nozzles is avoided, and stable droplet ejection is achieved.

The “liquid having functional properties” in the present invention is a liquid containing a functional material which can form a fine pattern on a substrate, one example thereof being light-curable resin solution, such as a resist solution, or a heat-curable resin solution, which is cured by heating.

The “side wall at least the part of which is constituted of the piezoelectric element” includes a mode including an electrode for applying a drive voltage to the part of the side wall that is constituted of the piezoelectric material. Furthermore, it also includes a mode where the side wall is constituted by joining together a plurality of piezoelectric elements.

The “liquid ejection head which ejects the droplets of the liquid by causing shear deformation of the piezoelectric elements” includes a so-called shear mode head.

The mode of “performing the droplet ejection at the same timing only from the nozzles belonging to the same group” includes a mode where the group is changed at each droplet ejection timing, and a mode where the group is changed after a plurality of consecutive droplet ejection timings.

In the liquid application device according to a second aspect of the present invention, the droplet ejection control device groups the nozzles into the groups the number of which is an integral multiple of three.

A desirable mode is one where the inkjet head based on a wall shear mode is used as the liquid ejection head according to this aspect.

The liquid application device according to a third aspect of the present invention further comprises a drive voltage generation device which is configured to generate, for each of the groups, a drive voltage to be applied to the piezoelectric elements belonging to each group.

According to this aspect, it is possible to operate the piezoelectric elements by using the drive voltages of different waveforms, for the respective groups.

In this aspect, it is possible to change the droplet ejection volume by altering the maximum amplitude (voltage) of the drive voltage, and it is possible to change the droplet ejection timing by altering the period of the drive voltage.

In the liquid application device according to a fourth aspect of the present invention, the droplet ejection control device controls the operation of the piezoelectric elements so as to operate the piezoelectric elements on both sides of one of the liquid chambers connected to one of the nozzles belonging to one of the groups that is designated to perform the droplet ejection and so as not to operate at least one of the piezoelectric elements on both sides of one of the liquid chambers connected to one of the nozzles belonging to one of the groups that is not designated to perform the droplet ejection.

According to this aspect, the liquid chamber corresponding to the nozzle adjacent to the nozzle performing the droplet ejection does not produce deformation required for the droplet ejection and does not perform the droplet ejection.

In the liquid application device according to a fifth aspect of the present invention, the liquid ejection head has a structure in which the nozzles are arranged over an entire length of the substrate in a direction perpendicular to a relative movement direction of the relative movement device, and has a structure in which the nozzles belonging to the same group are arranged in the direction perpendicular to the relative movement direction of the relative movement device, and the nozzles belonging to different groups are arranged at prescribed intervals apart along the relative movement direction of the relative movement device.

According to this aspect, it is possible to deposit the droplets onto positions on a square grid on the substrate, by arranging the nozzles belonging to different groups in an oblique direction with respect to the nozzle arrangement direction of the same group.

In this aspect, the nozzle arrangement pitch in the direction perpendicular to the direction of movement of the relative movement device is the droplet deposition pitch in the same direction on the substrate.

In the liquid application device according to a sixth aspect of the present invention, each of the side walls of the liquid chambers has a structure in which two piezoelectric elements are joined in a direction perpendicular to an arrangement direction of the liquid chambers, and the two piezoelectric elements have polarization directions opposite to each other along the direction perpendicular to the arrangement direction of the liquid chambers.

According to this aspect, the piezoelectric elements which are joined in the depth direction of the liquid chamber (the height direction of the side walls) respectively operate in the shear deformation mode, and therefore it is possible to further increase the amount of deformation of the piezoelectric elements and a stable droplet ejection volume can be ensured.

The liquid application device according to a seventh aspect of the present invention further comprises: a head turning device which is configured to turn the liquid ejection head within a plane parallel to a surface of the substrate on which the liquid having the functional properties is deposited; and a droplet deposition density changing device which is configured to change a droplet deposition density in a direction substantially perpendicular to a relative movement direction of the relative movement device by turning the liquid ejection head with the head turning device.

According to this aspect, it is possible to finely adjust the droplet deposition positions in the arrangement direction of the nozzles, in a range less than the nozzle arrangement pitch, without changing the nozzles performing the droplet ejection, and the average application amount can be adjusted in accordance with the droplet deposition pattern.

In this aspect, the occurrence of discontinuous points in the droplet deposition density can be avoided by composing the liquid ejection head in such a manner that all of the nozzles are turned integrally.

In the liquid application device according to an eighth aspect of the present invention, in one relative movement action of the substrate and the liquid ejection head, the droplet ejection control device causes only the piezoelectric elements corresponding to the nozzles belonging to one of the groups to operate in such a manner that the droplet ejection is performed only by the nozzles belonging to the one of the groups.

According to this aspect, even if the droplet deposition pitch is adjusted finely by turning the liquid ejection head, it is possible to eject droplets onto positions in a square grid on the substrate.

In the liquid application device according to a ninth aspect of the present invention, the droplet ejection control device causes the piezoelectric elements to operate in such a manner that a droplet deposition pitch in a direction substantially parallel to a relative movement direction of the relative movement device is altered within a range less than a minimum droplet deposition pitch.

According to this aspect, it is possible to finely adjust the droplet deposition pitch in the direction of movement of the relative movement device, without changing the nozzles performing the droplet ejection and the average application amount corresponding to the droplet deposition pattern.

If the droplet deposition density is changed by the droplet deposition density changing device according to the ninth aspect, then desirably, the droplet deposition density is changed in accordance with the seventh aspect.

In the liquid application device according to a tenth aspect of the present invention, the droplet ejection control device delays a timing of operation of the piezoelectric elements by adding a delay time which is less than a minimum droplet ejection period.

According to this aspect, a desirable mode is one which further comprises a delay time generation device which is configured to generate a delay time less than the minimum droplet ejection period.

In the liquid application device according to an eleventh aspect of the present invention, the droplet ejection control device changes a waveform of the drive voltage applied to the piezoelectric elements, for each of the groups.

According to this aspect, variation in the ejected droplet volume between the groups is reduced, and uniform ejection stability in all of the groups (nozzles) is guaranteed.

A specific example of this aspect is one where the waveform of the drive voltage is changed in accordance with the droplet ejection characteristics of each group.

In the liquid application device according to a twelfth aspect of the present invention, the droplet ejection control device changes a maximum voltage of the drive voltage applied to the piezoelectric elements, for each of the groups.

According to this aspect, it is possible to change the ejected droplet volume for each group, in accordance with the maximum value of the drive voltage, and the ejected droplet volume can be made uniform between the groups.

In the liquid application device according to a thirteenth aspect of the present invention, the droplet ejection control device changes a width of a maximum amplitude portion of the drive voltage applied to the piezoelectric elements, for each of the groups.

According to this aspect, it is possible to change the width of the maximum amplitude portion of the drive voltage (in other words, the pulse width) for each group, and hence the ejected droplet volume can be made uniform between the groups.

One example of the “maximum amplitude portion” in this aspect includes a portion corresponding to a state of holding a pull operation, in the drive voltage that performs pull-push driving of the piezoelectric elements.

The liquid application device according to a fourteenth aspect of the present invention further comprises: a droplet ejection action counting device which is configured to count a number of droplet ejection actions for each of the groups; and a droplet ejection action count storage device which is configured to store the counted number of droplet ejection actions for each of the groups.

According to this aspect, it is possible to ascertain the number of droplet ejection actions for each group, and to feed this information back into the control of droplet ejection.

The liquid application device according to a fifteenth aspect is the liquid application device according to the fourteenth aspect, further comprising a selection device which is configured to select one of the groups of the nozzles to be designated to perform the droplet ejection in accordance with results stored in the droplet ejection action count storage device, wherein the droplet ejection control device controls the operation of the piezoelectric elements in accordance with selection results of the selection device.

According to this aspect, it is possible to make the use frequency (droplet ejection frequency) uniform for the groups, thus contributing to improved durability of the liquid ejection head.

In the liquid application device according to a sixteenth aspect of the present invention, the liquid ejection head has a structure in which the nozzles each have substantially square planar shapes, and are arranged such that directions of edges of the square planar shapes are substantially parallel to an arrangement direction of the nozzles; and the liquid application device further comprises an observation device which is configured to observe the ejected droplets in a direction at substantially 45° with respect to a direction of a diagonal line of each of the nozzles.

According to this aspect, it is possible to select groups by using the observation results of the observation device.

In this aspect, a desirable mode is one which further comprises a judgment device which is configured to judge whether or not there is an abnormality in the nozzles, for each group, by using the observation results of the observation device.

Furthermore, in order to attain the aforementioned object, the liquid application method according to a seventeenth aspect of the present invention is a liquid application method of discretely depositing liquid having functional properties onto a substrate by: relatively moving the substrate and a liquid ejection head including: a plurality of nozzles configured to perform ejection of droplets of the liquid toward the substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles; and operating the piezoelectric elements at a prescribed droplet ejection period, wherein the nozzles are grouped into groups of not less than three in such a manner that adjacent nozzles belong to different groups, and operation of the piezoelectric elements is controlled in such a manner that the droplet ejection is performed at a same timing only through the nozzles belonging to a same group so as to deposit the liquid discretely onto the substrate.

In this aspect, a desirable mode is one which further comprises a droplet deposition density adjustment step for adjusting a droplet deposition density. Furthermore, a desirable mode is one which further comprises a droplet ejection action counting step of counting the number of droplet ejection actions for each of the groups, and a storing step of storing the counted number of the droplet ejection actions.

Furthermore, in order to attain the aforementioned object, a nanoimprint system according to an eighteenth aspect of the present invention comprises: a liquid ejection head including: a plurality of nozzles configured to perform ejection of droplets of liquid having functional properties toward a substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles; a relative movement device which is configured to cause relative movement of the substrate and the liquid ejection head; a droplet ejection control device which is configured to group the nozzles in the liquid ejection head into groups of not less than three in such a manner that adjacent nozzles belong to different groups, and is configured to control operation of the piezoelectric elements in such a manner that the droplet ejection is performed at a same timing only through the nozzles belonging to a same group so as to deposit the liquid discretely onto the substrate; and a transfer device which is configured to transfer a projection-recess pattern formed in a mold.

This aspect is especially suitable for nanoimprint lithography which forms a fine pattern at the sub-micron level. Moreover, it is also possible to form an imprint apparatus including the respective devices of this aspect.

In the nanoimprint system according to a nineteenth aspect of the present invention, the transfer device includes: a pressing device which is configured to press a surface of the mold in which the projection-recess pattern is formed, against a surface of the substrate on which the liquid has been applied; a curing device which is configured to cure the liquid located between the mold and the substrate; and a separating device which is configured to separate the mold and the substrate.

The nanoimprint system according to a twentieth aspect of the present invention further comprises: a separating device which is configured to separate the mold from the substrate, after transfer by the transfer device; a pattern forming device which is configured to form, on the substrate, a pattern corresponding to the projection-recess pattern of the mold, using a film which is formed of cured liquid and to which the projection-recess pattern has been transferred, as a mask; and a removal device which removes the film.

According to this mode, a desirable sub-micron fine pattern is formed.

### Advantageous Effects of Invention

According to the present invention, in a liquid application device including a liquid ejection head which ejects droplets of liquid from nozzles by causing shear deformation of piezoelectric elements each of which constitutes at least a part of each of side walls of liquid chambers connected respectively to the nozzles, since the nozzles are grouped in such a manner that adjacent nozzles belong to different groups, and the droplet ejection is performed only from the nozzles belonging to the same group at the same droplet ejection timing, then droplet ejection is never performed from adjacent nozzles at the same droplet ejection timing, cross-talk produced by droplet ejection from adjacent nozzles is avoided, and stable droplet ejection is achieved.

### BRIEF DESCRIPTION OF DRAWINGS

FIG. 1 is a drawing for describing respective steps of an imprint system according to the present invention.

FIG. 2 is a drawing for describing projection-recess patterns of silicon molds.

FIG. 3 is a drawing for describing the arrangement and spreading of droplets.

FIG. 4 is a drawing for describing another mode of the arrangement and spreading of droplets.

FIG. 5 is a drawing for describing yet another mode of the arrangement and spreading of droplets.

FIG. 6 is a general schematic drawing of the imprint system according to the present invention.

FIG. 7 is a drawing of a perspective view, an exploded perspective view and a partial enlarged view showing the general composition of the head shown in FIG. 6.

FIG. 8 is a drawing for showing a nozzle arrangement in the head shown in FIG. 7.

FIG. 9 is a drawing for describing operation of piezoelectric elements arranged in the head shown in FIG. 7.

FIG. 10 is a drawing for showing a structure of another embodiment of piezoelectric elements which generate shear mode deformation.

FIG. 11 is a principal block diagram showing a control system of the imprint system shown in FIG. 6.

FIG. 12 is a drawing for describing one embodiment of a drive voltage applied to the head shown in FIG. 7.

FIG. 13 is a drawing for showing another embodiment of the drive voltage shown in FIG. 12.

FIG. 14 is a drawing for describing change in the droplet deposition density in the x direction employed in the imprint system shown in FIG. 6.

FIG. 15 is a drawing for describing the droplet deposition pitch when the head shown in FIG. 7 is turned.

FIG. 16 is a drawing for showing another mode of the change in droplet deposition density shown in FIG. 14.

FIG. 17 is a block diagram showing a general composition of a drive signal generation unit in the imprint system shown in FIG. 6.

FIG. 18 is a block diagram showing another mode of the drive signal generation unit shown in FIG. 17.

FIG. 19 is a drawing for describing fine adjustment of the droplet deposition positions in the y direction.

FIG. 20 is a drawing for describing inspection of ejection employed for the head shown in FIG. 7.

FIG. 21 is a drawing for showing one embodiment of a method of fabricating nozzles relating to the head shown in FIG. 8.

FIG. 22 is a drawing for showing enlarged views of nozzles fabricated by the fabricating method shown in FIG. 21.

FIG. 23 is a drawing for showing results of evaluation experiments for liquid repellent films formed on a nozzle surface.

FIG. 24 is a drawing for describing a method of fabricating a silicon mold (master plate).

### DESCRIPTION OF EMBODIMENTS

Below, preferred embodiments of the present invention are described in detail with reference to the accompanying drawings.

### <Description of Nanoimprint Method>

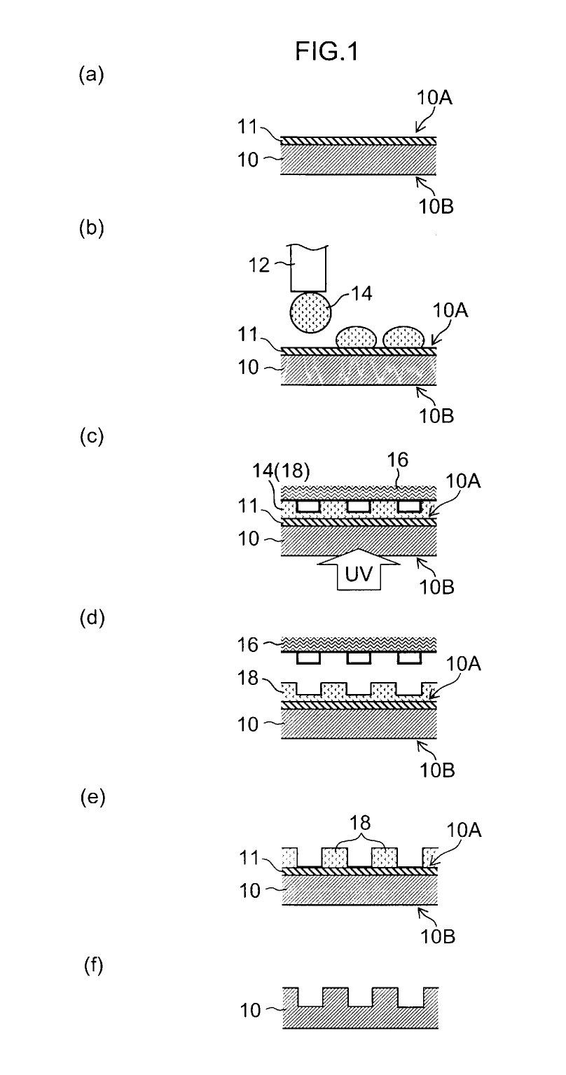

A nanoimprint method according to an embodiment of the present invention is described, following the sequence of steps with reference to FIG. 1. The nanoimprint method described in the present embodiment forms a fine pattern on a substrate by transferring a projection-recess pattern formed in a mold (for example, a silicon (Si) mold) to a light-curable resin film that has been formed on a substrate (for instance, a quartz substrate) by curing a liquid having functional properties (light-curable resin liquid), and then using the light-curable resin film as a mask pattern.

Firstly, the quartz substrate 10 (hereinafter referred simply to as “substrate”) shown in part (a) of FIG. 1 is prepared. The substrate 10 shown in part (a) of FIG. 1 has a hard mask layer 11 formed on a front side surface 10A, and a fine pattern is formed in the front side surface 10A. The substrate 10 should have a prescribed transmissivity for transmitting light, such as ultraviolet light, and should have a thickness of not smaller than 0.3 mm. Since the substrate 10 has the light transmissivity, it is possible to carry out exposure from the rear side surface 10B of the substrate 10.

Possible examples of the substrate 10 which is employed when using a silicon mold are: a substrate of which the surface has been coated with a silane coupling agent, a substrate on which a metal layer of Cr, W, Ti, Ni, Ag, Pt, Au, or the like, has been laminated, a substrate on which a metal oxide film layer of CrO₂, WO₂, TiO₂, or the like, has been laminated, or a substrate in which a surface of any of these laminated bodies is coated with a silane coupling agent.

More specifically, the hard mask layer 11 shown in part (a) of FIG. 1 employs a laminated body (coating material) such as the metal film or the metal oxide film described above. If the thickness of the laminated body exceeds 30 nm, the light transmissivity declines, and curing defects are liable to occur in the light-curable resin. Therefore, the thickness of the laminated body is not larger than 30 nm, and desirably not larger than 20 nm.

Here, the “prescribed transmissivity” should be such that a liquid having functional properties (for example, a liquid containing a light-curable resin denoted with reference numeral 14 in part (c) of FIG. 1) which is formed on the front side surface 10A of the substrate 10 is sufficiently cured by light that is irradiated from the rear side surface 10B of the substrate 10 and emitted from the front side surface 10A, for example, it is preferable that the transmissivity of the light having a wavelength of not shorter than 200 nm irradiated from the rear side surface is not less than 5%.

The structure of the substrate 10 can be a single-layer structure or a multiple-layer structure. The material of the substrate 10 can suitably employ silicon, nickel, aluminum, glass, resin, or the like, apart than quartz. These materials can be used independently, or suitably as a combination of two or more types.

The thickness of the substrate 10 is desirably not smaller than 0.05 mm, and more desirably not smaller than 0.1 mm. If the thickness of the substrate 10 is smaller than 0.05 mm, then it is possible that the substrate is warped upon making tight contact with the pattern receiving body and the mold, which results in failure to obtain uniform contact state. Furthermore, with a view to avoiding damage during handling or the application of pressure in the imprint process, it is more desirable for the thickness of the substrate 10 to be not smaller than 0.3 mm.

A plurality of droplets 14 of liquid containing the light-curable resin are discretely deposited from an inkjet head 12 onto the front side surface 10A of the substrate 10 (part (b) of FIG. 1: a droplet deposition step). As described in detail later, the “discretely deposited droplets” means a plurality of droplets which are deposited at prescribed intervals apart without making contact with other droplets that have been deposited at adjacent droplet deposition positions on the substrate 10.

In the droplet deposition step shown in part (b) of FIG. 1, the ejection volume, the deposition density, and the ejection (flight) speed of the droplets 14 are set (adjusted) in advance. For example, the droplet ejection volume and the droplet deposition density are adjusted so as to be relatively large in a region where recess sections of the projection-recess pattern of the mold (denoted with reference numeral 16 in part (c) of FIG. 1) have a larger spatial volume, and so as to be relatively small in a region where the recess sections have a smaller spatial volume or a region where there are no recess sections. After the adjustment, the droplets 14 are arranged on the substrate 10 in accordance with a prescribed droplet deposition arrangement (pattern).

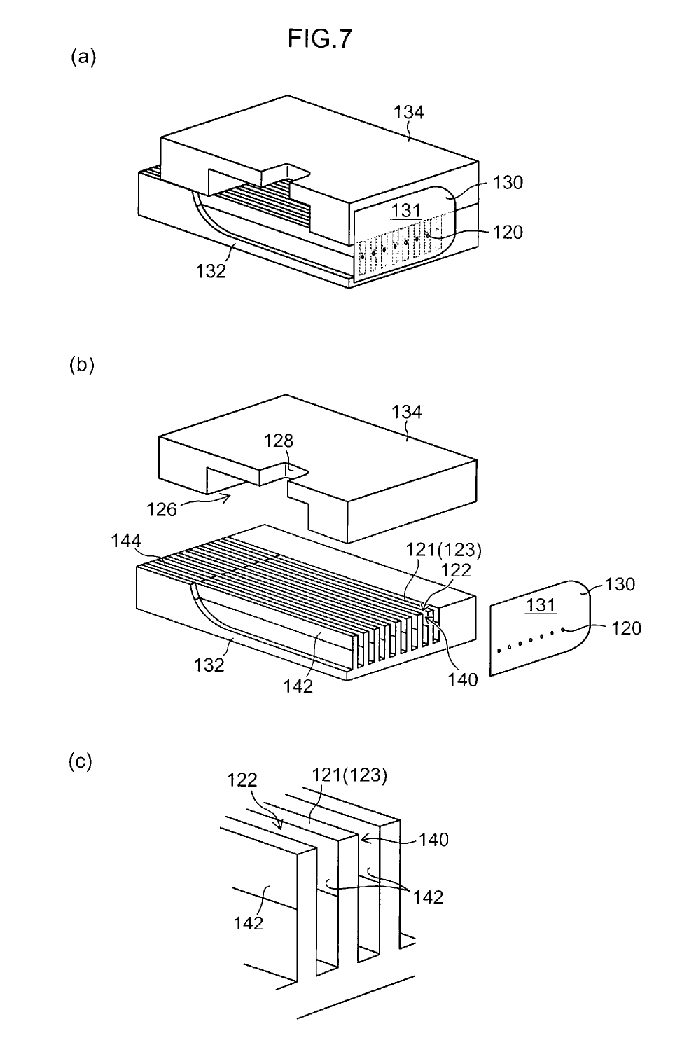

In the nanoimprint method according to the present embodiment, a plurality of nozzles (denoted with reference numeral 120 in FIG. 7) which are arranged in the inkjet head 12 are formed into groups corresponding to the structure of the inkjet head 12, and the ejection of droplets 14 is controlled for each of the groups of nozzles. Moreover, the deposition density of the droplets 14 is changed in two directions which are substantially perpendicular to each other on the front side surface 10A of the substrate 10, in accordance with the projection-recess pattern of the mold. Furthermore, the number of droplet ejection actions is counted for each of the groups, and droplet ejection by the respective groups is controlled so as to achieve a uniform droplet ejection frequency in the respective groups. The details of the droplet ejection control are described below.

After the droplet deposition step shown in part (b) of FIG. 1, the droplets 14 on the substrate 10 are spread by pressing a projection-recess pattern surface of the mold 16 in which the projection-recess pattern is formed, against the front side surface 10A of the substrate 10 with a prescribed pressing force, thereby forming a light-curable resin film 18 from the droplets 14 which have been spread and combined together (part (c) of FIG. 1: a light-curable resin film forming step).

In the light-curable resin film forming step, it is possible to reduce residual gas by lowering the atmosphere between the mold 16 and the substrate 10 to a low-pressure or vacuum state, before pressing the mold 16 against the substrate 10. However, in a high vacuum state, it is possible that the uncured light-curable resin film 18 evaporates and it becomes difficult to maintain a uniform film thickness. Therefore, it is preferable that the residual gas is reduced by changing the atmosphere between the mold 16 and the substrate 10 to a helium (He) atmosphere or a low-pressure He atmosphere. Since He passes through the quartz substrate 10, any trapped residual gas (He) gradually decreases. The He gas takes time to pass through the substrate, and therefore it is more desirable to employ the low-pressure He atmosphere.

The pressing force of the mold 16 is in a range of not less than 100 kPa and not more than 10 MPa. The relatively greater the pressing force, the greater the extent to which the fluidity of the resin is promoted, and the greater the extent to which the compression of the residual gas, and the dissolution of the residual gas into the light-curable resin or the passing of He through the substrate 10, is promoted, thus leading to improved tact time. However, if the pressing force is too great, then foreign matter embeds into the substrate 10 when the mold 16 makes contact with the substrate 10, and there is a possibility of causing damage to the mold 16 and the substrate 10. Therefore, the pressing force of the mold 16 is set to the range described above.

The range of the pressing force of the mold 16 is set, more desirably, to not less than 100 kPa and not more than 5 MPa, and even more desirably, not less than 100 kPa and not more than 1 MPa. The pressing force is set to not less than 100 kPa so that the space between the mold 16 and the substrate 10 is filled with the liquid 14 when imprint is carried out in the normal atmosphere, and so that the space between the mold 16 and the substrate 10 is pressurized at the atmospheric pressure (approximately 101 kPa).

Thereupon, ultraviolet light is irradiated from the rear side surface 10B of the substrate 10, thereby performing exposure of the light-curable resin film 18 and curing the light-curable resin film 18 (part (c) of FIG. 1: a light-curable resin film curing step). Although the present embodiment describes the light curing method in which the light-curable resin film 18 is cured by light (ultraviolet light), it is also possible to adopt another curing method, such as a thermal curing method in which a heat-curable resin film is formed using a liquid containing a heat-curable resin, and the heat-curable resin film is then cured by application of heat.

After sufficiently curing the light-curable resin film 18, the mold 16 is separated from the light-curable resin film 18 (part (d) of FIG. 1: a separating step). The method of separating the mold 16 can be any method which is not liable to damage the pattern in the light-curable resin film 18, and it is possible to employ a method in which the mold is separated gradually from the edge of the substrate 10, a method in which the mold 16 is separated while applying pressure from the side of the mold 16 to reduce the force applied to the light-curable resin film 18 at the boundary line where the mold 16 is being separated from the light-curable resin film 18 (pressing separating method), or the like. Moreover, it is also possible to adopt a method (heat-assisted separation) in which the vicinity of the light-curable resin film 18 is heated so as to reduce the adhesive force between the light-curable resin film 18 and the surface of the mold 16 at the interface between the mold 16 and the light-curable resin film 18, as well as lowering the Young's modulus of the light-curable resin film 18 and thus improving the flexibility of the film 18 and enabling the mold 16 to be separated without breaking of the film 18 due to deformation. It is also possible to use a composite method which suitably combines the methods described above.

The projection-recess pattern formed in the mold 16 is transferred to the light-curable resin film 18 formed on the front side surface 10A of the substrate 10, by the respective steps shown in parts (a) to (d) of FIG. 1. The light-curable resin film 18 formed on the substrate 10 is formed with a desirable projection-recess pattern which has a uniform remaining thickness and is free from defects, because the deposition density of the droplets 14 that form the light-curable resin film 18 is optimized in accordance with the projection-recess shape of the mold 16 and the properties of the liquid containing the light-curable resin. Next, a fine pattern is formed on the substrate 10 (or a metal film coating the substrate 10, or the like) by using the light-curable resin film 18 as a mask.

After the projection-recess pattern in the light-curable resin film 18 on the substrate 10 is transferred, the light-curable resin in the recess sections of the light-curable resin film 18 is removed, thereby exposing the front side surface 10A of the substrate 10, or a metal layer, or the like, formed on the front side surface 10A (part (e) of FIG. 1: an ashing step).

Thereafter, dry etching is carried out using the light-curable resin film 18 as a mask (part (f) of FIG. 1: an etching step), and when the light-curable resin film 18 is then removed, a fine pattern 10C corresponding to the projection-recess pattern that was formed in the light-curable resin film 18 is formed on the substrate 10. If a metal film or a metal oxide film has been formed on the front side surface 10A of the substrate 10, then the prescribed pattern is formed in this metal film or metal oxide film.

Concrete examples of dry etching include any method which can employ the light-curable resin film as the mask, such as ion milling, reactive ion etching (RIE), sputter etching, and the like. Of these, the ion milling and the reactive ion etching (RIE) are especially desirable.

The ion milling method is also known as ion beam etching, and involves introducing an inert gas, such as Ar, as an ion source, to generate ions. These ions are accelerated by passing through a grid, and then caused to collide with, and thereby etch, a specimen substrate. The ion source employed can be a Kaufman type source, a high-frequency source, an electron collider source, a duo plasmatron source, ECR (electron cyclotron resonance) source, or the like. The process gas used in ion beam etching can be argon gas, and the etchant in RIE can use fluorine gas or chlorine gas.

In the formation of the fine pattern using the nanoimprint method described in the present embodiment, the light-curable resin film 18 to which the projection-recess pattern of the mold 16 has been transferred is used as the mask, and the dry etching is carried out using this mask, which is free from non-uniformities in the thickness of the remaining film or defects due to the residual gas. Therefore, it is possible to form the fine pattern on the substrate 10 with high accuracy and high production yield.

It is also possible to employ the above-described nanoimprint method in order to fabricate a mold in a quartz substrate for use in nanoimprint.

### <Description of Projection-Recess Pattern in Mold>

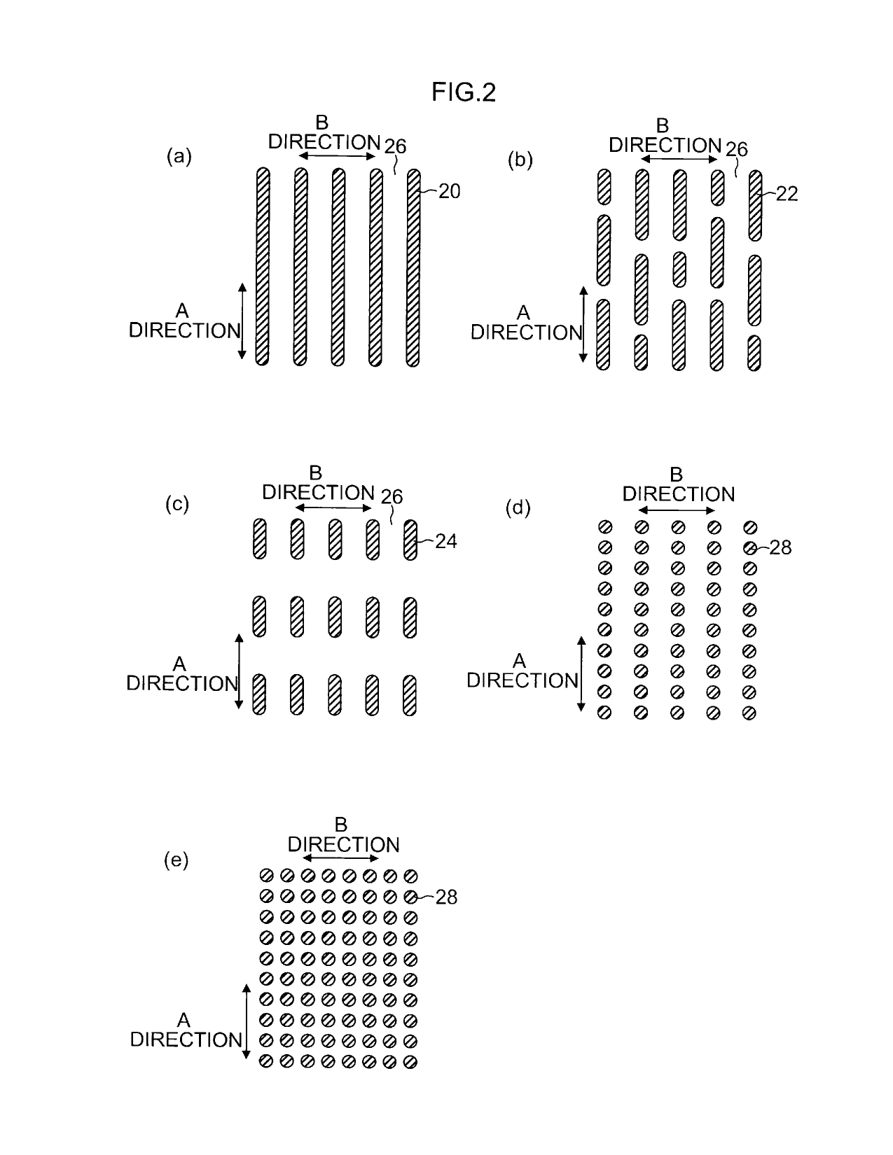

FIG. 2 is a drawing for showing concrete examples of the projection-recess pattern in the mold 16 shown in part (c) of FIG. 1. Part (a) of FIG. 2 shows a mode where projecting sections 20 having substantially the same length in a direction A are arranged equidistantly at prescribed intervals apart in a direction B, which is substantially perpendicular to the A direction. Part (b) of FIG. 2 shows a mode where projecting sections 22 are split appropriately in the A direction, and part (b) of FIG. 2 shows a mode where projecting sections 24 having a shorter length in the A direction than the projecting sections 20 shown in part (a) of FIG. 2 are arranged equidistantly at prescribed intervals apart in the A direction and the B direction (in this mode, the projecting sections 24 having substantially the same shape are arranged equidistantly in each of the A direction and the B direction).

In the case where the mold 16 formed with the projecting sections 20, 22, 24 having the above-described shapes is used, the droplets 14 (see part (b) of FIG. 1) are more liable to travel along recess sections 26 between the projecting sections 20 and to spread in the direction along the recess sections 26 (the direction A), then anisotropy occurs, and the shape of the spread droplets becomes a substantially oval shape.

Part (d) of FIG. 2 shows a mode where projecting sections 28 having a substantially circular shape in plan view are arranged equidistantly in the A direction and are also arranged equidistantly in the B direction, and furthermore, the projecting sections 28 are arranged more densely in the A direction than in the B direction, in such a manner that the arrangement pitch in the A direction is less than the arrangement pitch in the B direction. Also in the case where the mold 16 formed with the projecting sections 28 having the above-described shape and arrangement pattern, the droplets 14 are more liable to spread in the A direction, then anisotropy occurs, and the shape of the spread droplets becomes a substantially oval shape.

On the other hand, part (e) of FIG. 2 shows a mode where projecting sections 28 having a substantially circular shape in plan view are arranged equidistantly in both the A direction and the B direction, in such a manner that the arrangement pitch in the A direction is equal to the arrangement pitch in the B direction. When using the mold 16 in which the projecting sections 28 having the shape shown in part (e) of FIG. 2 are formed, no clear anisotropy appears in the spreading of the droplets 14.

Although the modes where the projecting sections 20 (22, 24, 28) are formed or arranged in straight lines are shown in parts (a) to (d) of FIG. 2, it is possible that the projecting sections are formed (arranged) in curved lines or are formed (arranged) in a pattern of meanders. The width (diameter) of the projecting sections 20 (22, 24, 28) and the width of the recess sections 26 is approximately 10 nm to 50 nm, and the height of the projecting sections 20, 22, 24, 28 (the depth of the recess sections 26) is approximately 10 nm to 100 nm.

### <Description of Droplet Deposition Arrangement and Spreading of Droplets>

The deposition positions (landing positions) of the droplets 14 which are deposited on the substrate 10 by the droplet deposition step shown in part (b) of FIG. 1, and the spreading of the droplets 14 by the light-curable resin film forming step shown in part (c) of FIG. 1 are described in detail below.

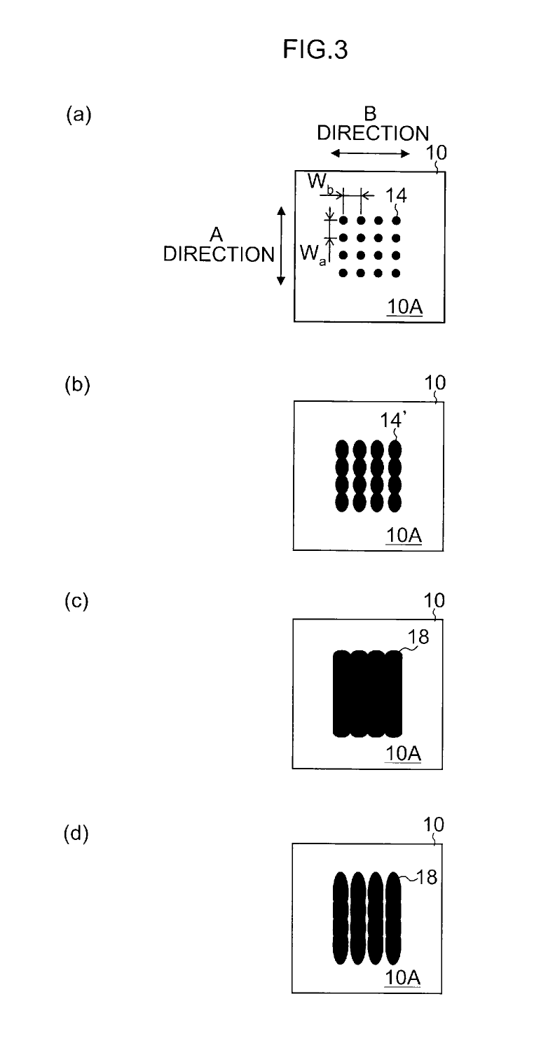

FIG. 3 is an illustrative drawing for showing schematic views of modes of anisotropically spreading the droplets 14, in which the stampers having the projection-recess patterns shown in parts (a) to (d) of FIG. 2 are employed. The droplets 14 shown in part (a) of FIG. 3 are arranged so as to have an arrangement pitch Wₐ in the A direction and an arrangement pitch W_{b} (<Wₐ) in the B direction.

The droplets 14 having the arrangement pattern in which the droplet deposition density is lower in the A direction than in the B direction as shown in part (a) of FIG. 3, spread in a substantially oval shape having the major axis direction in the A direction and the minor axis direction in the B direction as shown in part (b) of FIG. 3. In part (b) of FIG. 3, the droplets which are in the intermediate state of spreading are denoted with reference numeral 14′. When the droplets 14 are pressed under prescribed conditions, the droplets 14 which have been deposited at adjacent deposition positions combine with each other as shown in part (c) of FIG. 3, and the light-curable resin film 18 having the uniform thickness is formed. If the droplets 14 are arranged evenly both in the A direction and in the B direction, then the wetting and spreading varies, depending on the projection-recess shapes of the stamper, and therefore the density of the droplets is specified so as not to produce gaps (see part (d) of FIG. 3).

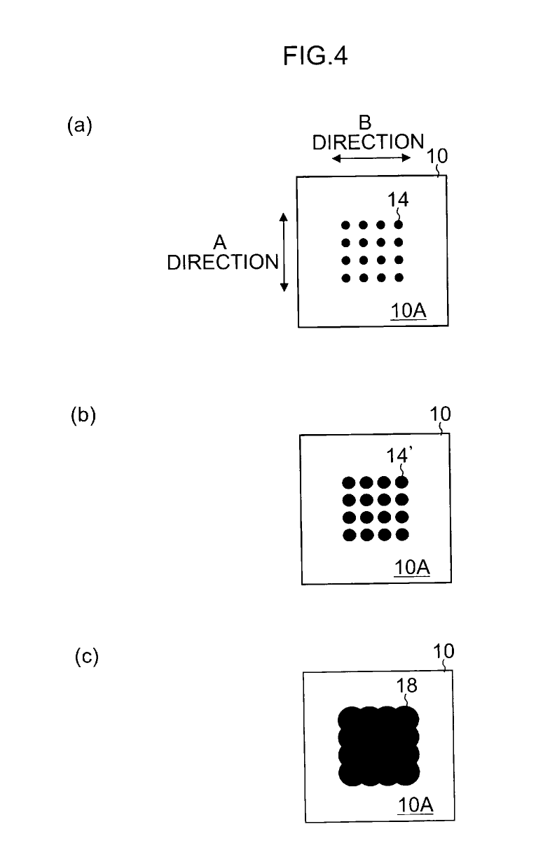

FIG. 4 is an illustrative drawing for showing schematic views of modes where the droplets 14 arranged equidistantly both in the A direction and in the B direction are spread isotropically (evenly), using, for instance, the stamper having the projection-recess pattern as shown in part (e) of FIG. 2.

The droplets 14 which have been deposited at prescribed droplet deposition positions on the front side surface 10A of the substrate 10 as shown in part (a) of FIG. 4 are pressed by the mold 16 (see part (c) of FIG. 1) and spread from the respective centers in substantially uniformly in the radial directions as shown in part (b) of FIG. 4. In part (b) of FIG. 4, the droplets which are in the intermediate state of spreading are denoted with reference numeral 14′. When the droplets 14 are pressed under prescribed conditions, the droplets 14 which have been deposited at adjacent deposition positions combine with each other as shown in part (c) of FIG. 4, and the light-curable resin film 18 having the uniform thickness is formed.

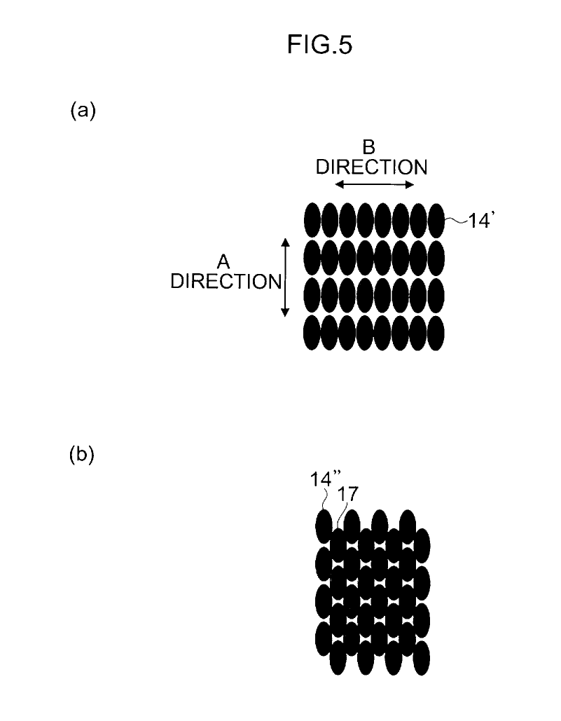

It is preferable that upon an approximation of the shapes of the droplets (droplets of the standard volume) 14′ having been spread as illustrated in part (a) of FIG. 5 by oval shapes, the droplets are rearranged in such a manner that the oval shapes are arranged in the most densely packed configuration. In the embodiment shown in part (b) of FIG. 5, the positions in the A direction of droplets 17 in even-numbered rows are changed (the droplet deposition positions in the A direction are shifted by ½ pitch) in such a manner that the centers of the droplets 17 in the even-numbered rows correspond to the edges in the A direction of droplets 14″ in odd-numbered rows, and the positions in the B direction are changed in such a manner that the arc portions of the oval shapes of the droplets 14″ in the odd-numbered rows touch the arc portions of the oval shapes of the droplets 17 in the even-numbered rows (the droplet deposition pitch in the B direction is reduced).

The arrangement pattern of the droplets is specified by using the respective centers of the oval shapes after the rearrangement as grid points (droplet deposition positions). Consequently, in the method of performing nanoimprint by applying the droplets 14 having the light-curable properties by using the inkjet method, it is possible to suppress the occurrence of non-uniformities in the thickness of the remaining film of the light-curable resin film 18 to which the projection-recess pattern has been transferred, and the occurrence of defects caused by residual gas.

The suitable application amount of the droplets 14 is in a range which yields a thickness of the light-curable resin film 18 of not smaller than 5 nm and not larger than 200 nm, after pressing by the mold 16. In particular, in order to achieve good quality of the pattern formed on the substrate 10 after the subsequent step of a lithography process by dry etching, or the like, the thickness of the light-curable resin film 18 is desirably not larger than 15 nm and more desirably not larger than 10 nm. It is even more desirable if the thickness of the light-curable resin film 18 is not larger than 5 nm. Furthermore, the standard deviation (a value) of the remaining film thickness is desirably not larger than 5 nm, more desirably, not larger than 3 nm, and even more desirably, not larger than 1 nm.

### <Description of Nanoimprint System>

A nanoimprint system for achieving the above-described nanoimprint method is explained below.

### <General Composition>

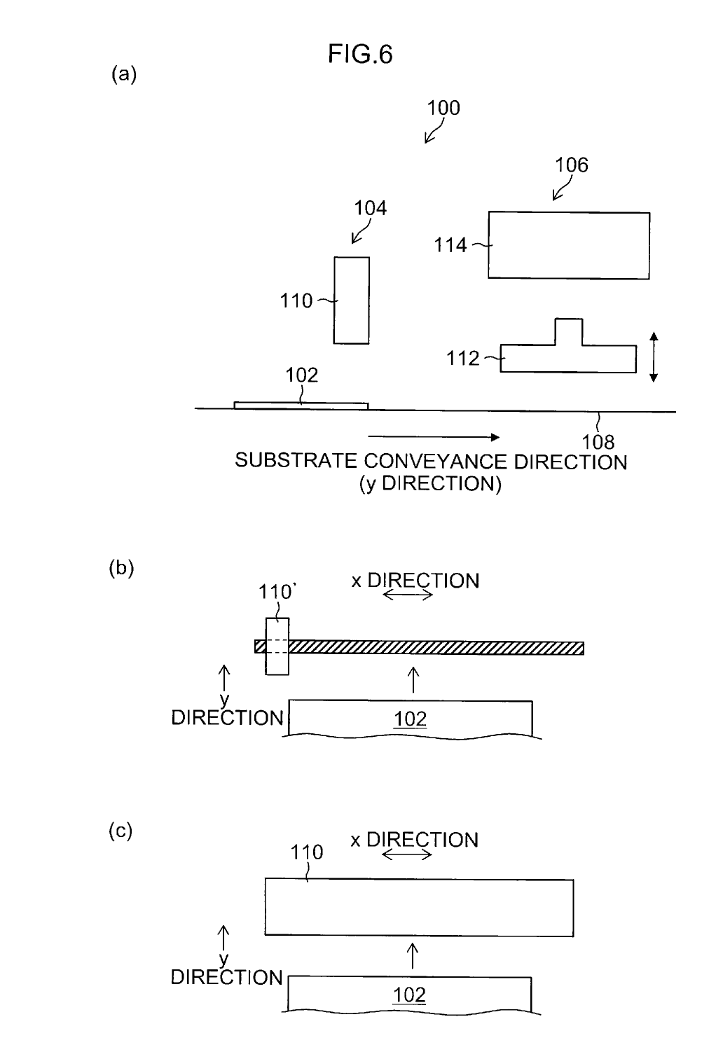

FIG. 6 is a general schematic drawing of the nanoimprint system according to an embodiment of the present invention. The nanoimprint system 100 shown in part (a) of FIG. 6 includes: a resist application unit 104, which applies a resist solution (the solution containing the light-curable resin) onto a substrate 102 made of silicon or quartz glass; a pattern transfer unit 106, which transfers the desired pattern to the resist having been applied to the substrate 102; and a conveyance unit 108, which conveys the substrate 102.

The conveyance unit 108 includes a conveyance device which secures and conveys the substrate 102, such as a conveyance stage, for instance, and conveys the substrate 102 in a direction from the resist application unit 104 to the pattern transfer unit 106 (hereinafter referred also to as the “y direction”, “substrate conveyance direction”, or “sub-scanning direction”), while holding the substrate 102 on the surface of the conveyance device. As a concrete example of the conveyance device, it is possible to adopt a combination of a linear motor and an air slider, or a combination of a linear motor and an LM guide, or the like. It is also possible to adopt a composition in which either the resin application unit 104 or the pattern transfer unit 106, or both, are moved, instead of moving the substrate 102. Here, the “y direction” in FIG. 6 corresponds to the “A direction” in FIGS. 2 to 5.

The resist application unit 104 includes an inkjet head 110 in which a plurality of nozzles (not shown in FIG. 6, shown and denoted with reference numeral 120 in FIG. 7) are formed, and applies the resist solution onto the surface of the substrate 102 (the resist application surface) by ejecting droplets of the resist solution through the nozzles.

The head 110 is a serial type head having a structure in which the nozzles are arranged in the y direction, liquid ejection being carried out in the x direction by performing a scanning action throughout the whole width of the substrate 102 in the x direction. As shown in part (b) of FIG. 6, in the liquid ejection by the serial type head 110′, when the liquid ejection in the x direction has terminated, the substrate 102 and the head 110′ are moved relatively to each other in the y direction and the next liquid ejection operation in the x direction is carried out. By repeating the operation, it is possible to deposit droplets over the whole surface of the substrate 102. However, if the length in the y direction of the substrate 102 can be covered by one scanning action in the x direction, then the relative movement of the substrate 102 and the head 110′ in the y direction is not necessary.

On the other hand, as shown in part (c) of FIG. 6, it is also possible to employ a long full line head 110 having a structure in which the nozzles are arranged in a row through the maximum width of the substrate 102 in the x direction (hereinafter referred also to as the “substrate width direction” or the “main scanning direction”), which is perpendicular to the y direction. In the liquid ejection using the full line type of head 110, it is possible to arrange the droplets at desired positions on the substrate 102 by performing just one operation of moving the substrate 102 and the head 110 relatively to each other in the substrate conveyance direction, without moving the head 110 in the x direction, and therefore it is possible to raise the resist application rate. Here, the above-described “x direction” corresponds to the “B direction” in FIGS. 2 to 5.

The pattern transfer unit 106 includes: a mold 112, in which the desired projection-recess pattern to be transferred to the resist on the substrate 102 is formed; and an ultraviolet light irradiation device 114, which irradiates ultraviolet light, and transfers the pattern to the resist solution on the substrate 102 by pressing the mold 112 against the surface of the substrate 102 to which the resist has been applied while irradiating ultraviolet light from the rear side of the substrate 102 to cure the resist solution on the substrate 102.

The mold 112 is made of a light transmitting material which can transmit ultraviolet light irradiated from the ultraviolet irradiation device 114. It is possible to use glass, quartz, sapphire, transparent plastics (for example, acrylic resin, hard vinyl chloride, or the like) as the light-transmitting material. Thereby, when ultraviolet light is irradiated from the ultraviolet light irradiation device 114 arranged above the mold 112 (on the opposite side from the substrate 102), ultraviolet light is irradiated onto the resist solution on the substrate 102 without being shielded by the mold 112 and the resist can therefore be cured.

The mold 112 is composed movably in the vertical direction in part (a) of FIG. 6 (in the directions indicated by the arrow); the mold 112 is moved downward while maintaining a state where the pattern forming surface of the mold 112 is substantially parallel to the surface of the substrate 102, and contacts the whole surface of the substrate 102 virtually simultaneously, thereby performing pattern transfer.

### <Composition of Head>

The structure of the head 110 is described in detail below. Part (a) of FIG. 7 is a perspective diagram showing an approximate composition of a head 110, and part (b) of FIG. 7 is an exploded perspective diagram of the head 110. Part (c) of FIG. 7 is a partial enlarged diagram of part (b) of FIG. 7. The head 110 to be described with reference to FIG. 7 is a so called “shear-mode type” (wall shear type) of inkjet head.

As shown in part (a) of FIG. 7, the head 110 includes: a nozzle plate 130, in which the nozzles are formed; a liquid chamber plate 132, in which a plurality of liquid chambers 122 (see part (b) of FIG. 7) connected respectively to the nozzles 120 are formed; and a cover plate 134, which seals the liquid chamber plate 132, the cover plate 134 being assembled with the liquid chamber plate 132 and the nozzle plate 130 being bonded to the surface of the liquid chamber plate 132 where the liquid chambers 122 are open. The head 110 is arranged in such a manner that a nozzle surface 131, which is the surface of the nozzle plate 130 on the opposite side to the liquid chamber plate 132, opposes the substrate 102 shown in FIG. 6.

As shown in part (b) of FIG. 7, the liquid chamber plate 132 is formed with the liquid chambers 122, which are separated on either side by side walls (partition walls) 121 in a direction substantially perpendicular to the surface on which the nozzle plate is bonded. A bonding section 144 for bonding the cover plate 134 is arranged on the opposite side of the liquid chambers 122 from the surface where the nozzle plate 130 is bonded, and a prescribed region in the direction in which the liquid chambers 122 are formed from the surface of the liquid chambers 122 where the nozzle plate 130 is bonded forms a bonding section 145 to which the cover plate 134 is bonded.

Each of the side walls 121 defining the liquid chambers 122 is made of a piezoelectric material, and is formed with an electrode 140 on one surface along the formation direction of the liquid chamber 122 so as to correspond to the entire length in the formation direction of the liquid chamber. The other surface of each of the side walls 121 is formed with an electrode 142 having the similar length to the electrode 140. When a prescribed drive voltage is applied between the electrode 140 and the electrode 142, the region of the side wall 121 to which the electrode 140 and the electrode 142 are bonded functions as a piezoelectric element that generates shear mode deformation.

The piezoelectric material employed in the side walls 121 can be an organic material or a piezoelectric non-metallic material, for example, provided that the material produces deformation when a voltage is applied thereto. Examples of the organic materials include an organic polymer, and a composite material made of an organic polymer and a non-metallic material. Examples of the piezoelectric non-metallic material include alumina, aluminum nitride, zirconia, silicon, silicon nitride, silicon carbide, quartz, and non-polarized PZT (lead zirconate titanate).

A possible method for forming the liquid chamber plate 132 is one in which grooves that are to become liquid chambers 122 are formed by a machining process, such as dicing, in a ceramic substrate obtained by shaping and calcining bulk material, and a metal material that is to form electrodes 140 and 142 is deposited on the inner surfaces of the grooves (liquid chambers 122) using a technique such as plating, vapor deposition, sputtering, or the like. For the ceramic substrate can be PZT (PbZrO₃—PbTiO₃), PZT with an added third component (where the third component is Mg_{1/3}Nb_{2/3})O₃, Pb(Mn_{1/3}Sb_{2/3})O₃, Pb(Co_{1/2}Nb_{2/3})O₃, or the like, and BaTiO₃, ZnO, LiTaO₃, or the like). The substrate to form the liquid chamber plate 132 can be one formed using a sol gelation method, a laminated substrate coating method, or the like.

The metallic material used in the electrodes 140 and 142 can be platinum, gold, silver, copper, aluminum, palladium, nickel, tantalum, titanium, or the like, of which gold, aluminum, copper and nickel are especially desirable from the viewpoint of electrical properties and processabilities. As shown in part (c) of FIG. 7, the side wall 121 of the liquid chamber 122 has the structure in which the electrodes 140 and 142 are formed in a region of substantially ½ of the depth of the liquid chamber 122, from the end portion on the surface where the cover plate 134 is bonded.

The cover plate 134 is a member for sealing the surface of the liquid chamber plate 132 where the liquid chambers are formed, and a recess section that is to become a liquid supply channel 126 is arranged on the surface to which the liquid chamber plate 132 is bonded, while a hole 128 communicating with the recess section to be the liquid supply channel 126 is arranged from the surface (the outer surface) opposite to the surface where the liquid chamber plate 132 is bonded. The hole 128 connects with a tank (not shown) through a liquid flow channel, such as a tube (not shown).

More specifically, the hole 128 is a liquid supply port for supplying the liquid to the interior of the head 110, and the liquid supplied from an external source through the liquid supply port 128 is conveyed to the respective liquid chambers 122 through the liquid supply channel 126. The cover plate 134 can use a material such as an organic material or a non-metallic piezoelectric material, or the like, provided that the material has prescribed rigidity and prescribed liquid resisting properties.

The nozzle plate 130 is formed with apertures of the nozzles 120 at an arrangement pitch corresponding to the arrangement interval between the liquid chambers 122 formed in the liquid chamber plate 132. The nozzle plate 130 having this structure is bonded to the liquid chamber plate 132 after aligning the positions of the nozzles 120 with the positions where the liquid chambers 122 are formed in the liquid chamber plate 132, and the liquid chambers 122 and the nozzles 120 are mutually connected in a one-to-one relationship. The alignment direction of the liquid chambers 122 and the alignment direction of the nozzles 120 in FIG. 7 correspond to the B direction in FIGS. 2 to 4, and correspond to the x direction substantially perpendicular to the y direction in FIG. 6.

Although the details are described later, the head 110 described in the present embodiment employs a silicon substrate as the nozzle plate 130, and the nozzle apertures are processed in the silicon substrate by anisotropic etching. The nozzle plate 130 can use a synthetic resin, such as polyimide resin, polyethylene terephthalate resin, a liquid crystal polymer, aromatic polyamide resin, polyethylene naphthalate resin, polysulfone resin, or the like, and can also use a metal material, such as stainless steel.

The head 110 described in the present embodiment has a structure in which the nozzles 120 adjacent to each other do not perform droplet ejection at the same timing. More specifically, when one of the nozzles performs droplet ejection at certain timing, other nozzles connected to the adjacent liquid chambers which share the side walls 121 with the liquid chamber connected to the one of the nozzles are set as idle nozzles which do not perform droplet ejection at that timing. In other words, in the head 110, one in three nozzles is capable of performing droplet ejection at the same timing, and there are at least two nozzles between the nozzles which are capable of performing droplet ejection at the same timing.

Furthermore, in the head 110 described in the present embodiment, the nozzles 120 are formed into groups, in such a manner that the nozzles which cannot perform droplet ejection at the same timing do not belong to the same group. More specifically, if m is an integer not less than 3, then the nozzles at intervals of m nozzles apart are set as the nozzles belonging to the same group. For example, if m=3, then the nozzles 120 are arranged as follows: a nozzle belonging to the first group, a nozzle belonging to the second group, a nozzle belonging to the third group, a nozzle belonging to the first group, and so on. In this nozzle arrangement, the nozzle pitch in each group in the alignment direction of the liquid chambers 122 is m times the minimum nozzle pitch in the alignment direction of the liquid chambers 122.

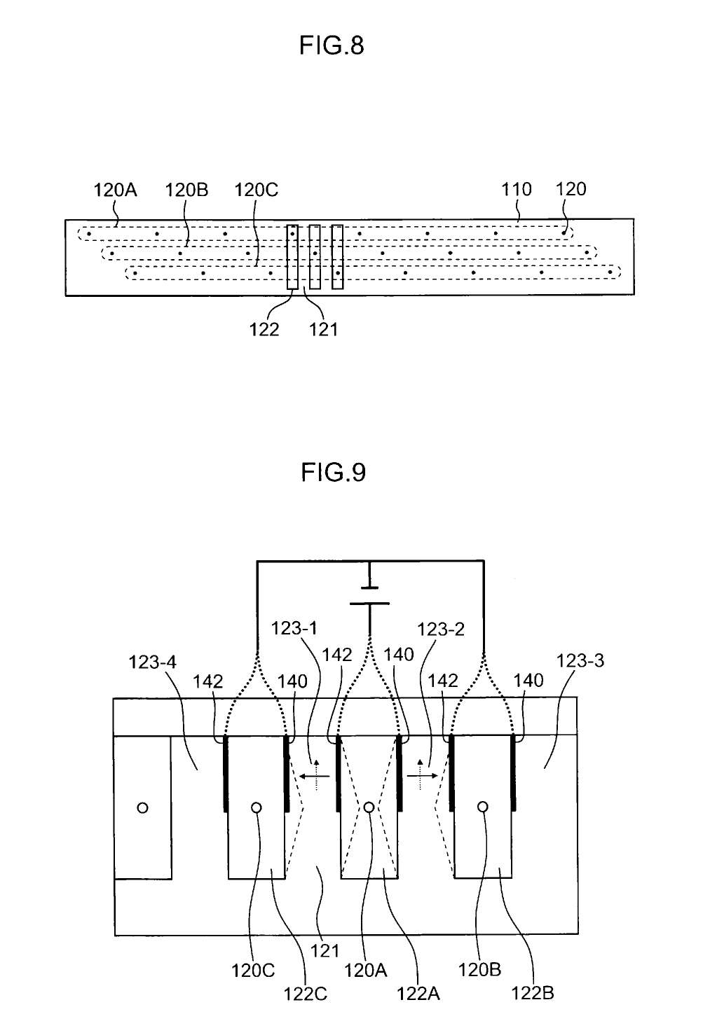

FIG. 8 is a plan view of the head 110 (nozzle surface 131) in which the nozzles 120 are arranged at staggered positions in each group. In the nozzle plate 130 shown in FIG. 8, the nozzles 120A belonging to the first group, the nozzles 120B belonging to the second group and the nozzles 120C belonging to the third group are arranged in the respective rows along the alignment direction of the liquid chambers 122, whereas the nozzles 120A belonging to the first group, the nozzles 120B belonging to the second group and the nozzles 120C belonging to the third group are arranged at positions staggered from each other in the direction substantially perpendicular to the alignment direction of the liquid chambers 122. In FIG. 8, the nozzles 120A belonging to the first group, the nozzles 120B belonging to the second group and the nozzles 120C belonging to the third group are respectively enclosed with dashed lines.

For example, the nozzles 120B belonging to the second group are arranged in the substantially central position in the direction substantially perpendicular to the alignment direction of the liquid chambers 122, and the nozzles 120A belonging to the first group and the nozzles 120C belonging to the third group, which are adjacent to the nozzles 120B, are arranged on either side of the nozzles 120B in positions that are mutually opposing in the direction substantially perpendicular to the alignment direction of the liquid chambers 122.

### <Description of Piezoelectric Element>

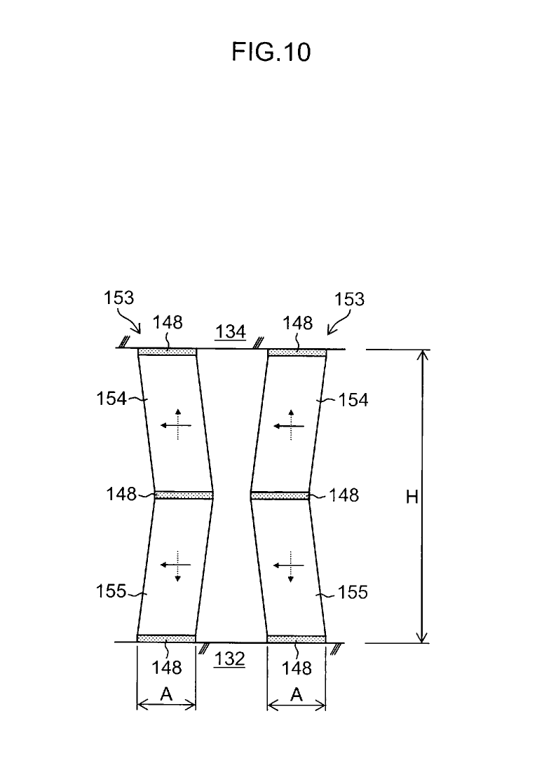

The piezoelectric elements arranged in the head 110 are described below. As described above, the piezoelectric elements are the portions of the side walls arranged between the liquid chambers 122 where the electrodes 140 and 142 are formed, and in FIGS. 9 and 10, the piezoelectric elements are denoted with reference numerals 123-1 to 123-4.

FIG. 9 is a diagram illustrating operation of the piezoelectric elements 123-1 to 123-4 and depicts a case where droplet ejection is performed through the nozzle 120A. In FIG. 9, the shape of the piezoelectric elements 123-1 to 123-4 which are in the stationary state is indicated with the solid lines, and the shape of the piezoelectric elements 123-1 and 123-2 which are in the shear deformation is indicated with the dashed lines. The piezoelectric elements 123-1 to 123-4 shown in FIG. 9 are polarized in the direction from the lower side to the upper side in the drawing (as indicated with the dotted-line arrow).

When electric fields in the directions from the inner side toward the outer side of the liquid chamber 122A (as indicated with the solid-line arrows in FIG. 9) are applied respectively to the piezoelectric elements 123-1 and 123-2, which constitute the side walls 121 defining the liquid chamber 122A connecting to the nozzle 120A, thereby causing the piezoelectric elements 123-1 and 123-2 to deform toward the inner side of the liquid chamber 122A, then a droplet having a volume corresponding to the volume of the liquid chamber 122A removed by the deformation of the piezoelectric elements 123-1 and 123-2 is ejected through the nozzle 120A.

In this case, in the liquid chamber 122B adjacent to the liquid chamber 122A, the piezoelectric element 123-2 which the liquid chamber 122B shares with the liquid chamber 122A deforms toward the outer side of the liquid chamber 122B, and the piezoelectric element 123-3 which is not shared with the liquid chamber 122A does not deform. Therefore, droplet ejection is not performed through the nozzle 120B connected to the liquid chamber 122B. Similarly, in the liquid chamber 122C adjacent to the liquid chamber 122A on the opposite side from the liquid chamber 122B, the piezoelectric element 123-1 which the liquid chamber 122C shares with the liquid chamber 122A deforms toward the outer side of the liquid chamber 122C, and the piezoelectric element 123-4 which is not shared with the liquid chamber 122A does not deform. Therefore, no droplet ejection is performed through the nozzle 120C connected to the liquid chamber 122C.

In other words, through applying the drive voltage by using the electrodes 140 and 142 formed on the inner sides of the liquid chamber 122A as the positive electrodes and using the electrodes 142 of the piezoelectric element 123-1 and the electrode 140 of the piezoelectric element 123-2 as the negative electrodes (at reference potential), then the shear mode deformation is generated in each of the piezoelectric elements 123-1 and 123-2, and a droplet is ejected through the nozzle 120A. When performing droplet ejection through the nozzle 120B belonging to the second group or the nozzle 120C belonging to the third group, a drive voltage is applied by using the electrodes 140 and 142 on the inner sides of the liquid chamber 122 connected to the nozzle 120 through which the droplet ejection is to be performed, as positive electrodes, and using the electrodes 140 and 142 on the outer side, as negative electrodes, in such a manner that the shear mode deformation is generated in the piezoelectric elements 123 which constitute the side walls of the liquid chamber 122 connected to the nozzle 120 through which the droplet ejection is to be performed.

FIG. 10 is a drawing for showing a structure of another embodiment of piezoelectric elements which generate shear mode deformation. The piezoelectric element 153 shown in FIG. 10 has a structure in which a piezoelectric element 154 having an upward direction of polarization in the drawing and a piezoelectric element 155 having a downward direction of polarization in the drawing are bonded in a direction parallel to the direction of polarization. One end surface of the piezoelectric element 154 in the direction of polarization (the upper end surface in the drawing) is bonded to the cover plate 134 through adhesive 148, and the other end surface thereof (the lower end surface in the drawing) is bonded to one end surface of the piezoelectric element 155 through adhesive 148. Furthermore, the other end surface of the piezoelectric element 155 (the lower end surface in the drawing) is bonded to the liquid chamber plate 132 through adhesive 148.

When electric fields in the directions from the inner side toward the outer side of the liquid chamber 122 are applied to the piezoelectric elements 153 having the structure shown in FIG. 10, the shear stress is generated in the directions indicated with the thick-line arrows and the piezoelectric elements 153 deform into dogleg shapes, thereby reducing the volume of the liquid chamber 122. The directions of the polarization of the piezoelectric elements 154 and 155 are indicated with the dotted-line arrows, and the directions of the electric fields are indicated with the solid-line arrows.

Here, if the piezoelectric constant of the piezoelectric element 153 is taken as d₁₅, the height of the piezoelectric element 153 is taken as H, the thickness of the piezoelectric element 153 is taken as A, and the potential difference (voltage) of the applied electric field is taken as V, then the average amount of displacement δP is expressed as the formula [Math. 1] below:

$$δ P = \frac{{d}_{15} \times H \times V}{4 \times A} . \qquad [ Math . 1 ]$$

The piezoelectric element 153 having this structure constitutes a structure in which the whole of the side wall 121 deforms, and therefore it is possible to increase the amount of displacement of the piezoelectric element in comparison with the structure shown in FIG. 9 in which only a portion (upper portion) of the side wall 121 deforms.

### <Description of Control System>

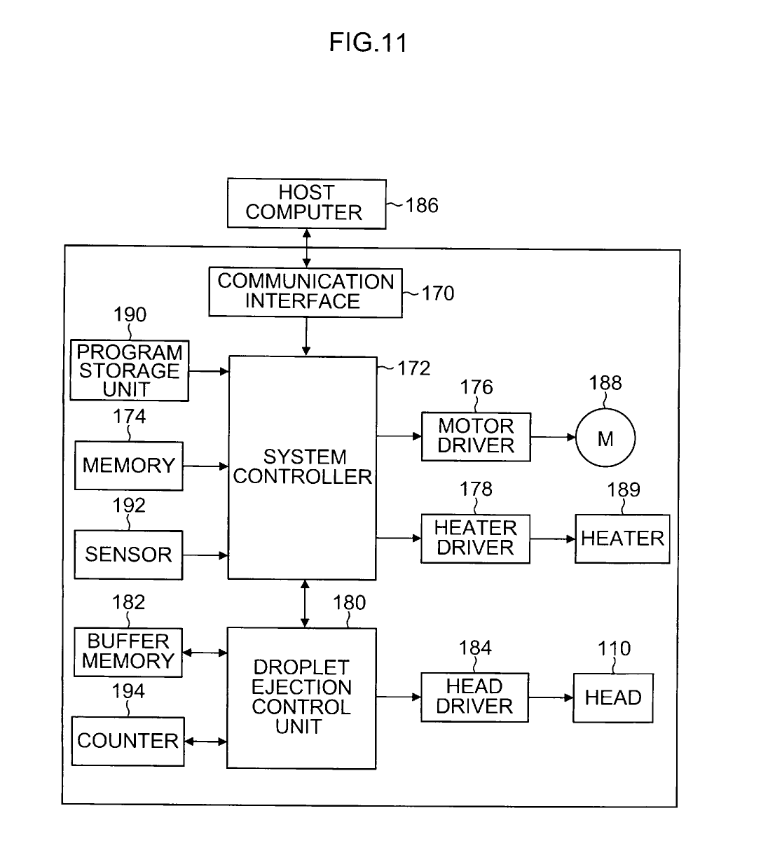

FIG. 11 is a block diagram showing a control system relating to the resist application unit 104 in the nanoimprint system 100. As shown in FIG. 11, the control system includes a communication interface 170, a system controller 172, a memory 174, a motor driver 176, a heater driver 178, a droplet ejection controller 180, a buffer memory 182, a head driver 184, and the like.

The communication interface 170 is an interface unit which receives data representing the arrangement (application pattern) of the resist solution which is received from a host computer 186. For the communication interface 70, a serial interface, such as USB (Universal Serial Bus), IEEE 1394, Ethernet, or a wireless network, or the like, or a parallel interface, such as a Centronics interface, or the like, can be used. It is also possible to install a buffer memory (not shown) for achieving high-speed communications.

The system controller 172 is a control unit which controls the respective units of the communication interface 170, the memory 174, the motor driver 176, the heater driver 178, and the like. The system controller 172 is constituted of a central processing unit (CPU) and peripheral circuits, and the like, and controls communications with the host computer 186, and reading and writing of data from and to the memory 174, as well as generating control signals to control motors 188 of the conveyance system and heaters 189.

The memory 174 is a storage device which includes a temporary storage area for data and a work area for the system controller 172 to carry out calculations. The data indicating the arrangement of the resist solution which has been inputted through the communication interface 170 is read into the nanoimprint system 100 and stored temporarily in the memory 174. Apart from a memory formed of semiconductor elements, it is also possible to use a magnetic medium, such as a hard disk, for the memory 174.

A control program for the nanoimprint system 100 is stored in the program storage unit 190. The system controller 172 reads out various control programs stored in the program storage unit 190, as appropriate, and executes the read control programs. The program storage unit 190 can employ a semiconductor memory, such as a ROM or EEPROM, or can use a magnetic disk, or the like. An external interface can be provided to use a memory card or a PC card. Of course, it is also possible to arrange a plurality of recording media, of these recording media.

The motor driver 176 is a driver (drive circuit) which drives the motors 188 in accordance with instructions from the system controller 172. The motors 188 include a motor for driving the conveyance unit 108 in part (a) of FIG. 6 and a motor for raising and lowering the mold 112.

The heater driver 178 is a driver which drives the heaters 189 in accordance with instructions from the system controller 172. The heaters 189 include temperature adjustment heaters arranged in the respective units of the nanoimprint system 100.

The droplet ejection controller 180 is a control unit which has signal processing functions for carrying out processing, correction, and other treatments in order to generate droplet ejection control signals on the basis of the resist solution arrangement data in the memory 174 in accordance with the control of the system controller 172, and which supplies the droplet ejection controls signal thus generated to the head driver 184. Prescribed signal processing is carried out in the droplet ejection controller 180, and the ejection amounts, the deposition positions and the ejection timing of droplets of the resist solution ejected from the head 110 are controlled through the head driver 184 on the basis of the droplet ejection data. By this means, a desired arrangement (pattern) of droplets of the resist solution is achieved.

The droplet ejection controller 180 is provided with the buffer memory 182, and data, such as the droplet ejection data and parameters, is temporarily stored in the buffer memory 182 when the droplet ejection data is processed in the droplet ejection controller 180. The aspect shown in FIG. 11 is one in which the buffer memory 182 accompanies the droplet ejection controller 180; however, the memory 174 can also serve as the buffer memory 182. Also possible is an aspect in which the droplet ejection controller 180 and the system controller 172 are integrated to form a single processor.

The head driver 184 generates drive signals for driving the piezoelectric elements 123 (see FIG. 9) in the head 110, on the basis of the droplet ejection data supplied from the droplet ejection controller 180, and supplies the generated drive signals to the piezoelectric elements 123. The head driver 184 can also incorporate a feedback control system for maintaining uniform drive conditions in the head 110.

As described previously, in the head 110 according to the present embodiment, the nozzles 120 are grouped into the groups of not less than three, and the droplet ejection is controlled for each of the groups. The droplet ejection controller 180 selects the group that performs the droplet ejection at the same timing, and the head driver 184 supplies the drive voltage to the piezoelectric elements 123 which constitute the side walls 121 of the liquid chambers 122 connected to the nozzles 120 belonging to that group in accordance with instructions from the droplet ejection controller 180 (see FIGS. 7 and 8).

In other words, the droplet ejection is performed only from the nozzles belonging to the selected group, at the same drive timing, and no droplet ejection is performed from the nozzles belonging to the other groups which have not been selected. For example, when the first group is selected at the particular drive timing and the droplet ejection is performed from the nozzles 120A belonging to the first group, no droplet ejection is performed at that drive timing from the nozzles 120B belonging to the second group and the nozzles 120C belonging to the third group.

On the other hand, when the second group is selected at another drive timing and the droplet ejection is performed from the nozzles 120B belonging to the second group, no droplet ejection is performed at that drive timing from the nozzles 120A belonging to the first group and the nozzles 120C belonging to the third group. Thus, the head is composed in such a manner that the single group is selected at each droplet ejection timing, two or more groups cannot be selected at the same drive timing, and the droplet ejection is performed only from the nozzles 120 belonging to the single group that has been selected.

A sensor 192 is arranged in order to determine the state of flight of the droplets ejected from the head 110. One example of the composition of the sensor 192 is a composition including a light emitting unit (for example, a strobe device which emits strobe light) and a light receiving unit (for example, a CCD image sensor or other imaging device). It is possible to determine the speed of flight of the droplet, the direction of flight of the droplet and the volume of the droplet, and the like, by this optical sensor. The information obtained by the sensor 192 is sent to the system controller 172 and is fed back to the droplet ejection controller.

A counter 194 counts up the number of droplet ejection actions for each group set in respect of the nozzles 120. In the present embodiment, the number of droplet ejection actions is counted for each group, on the basis of the droplet ejection data, and this count data is stored in a prescribed storage unit (for example, the memory 174). This count data is used to adjust the use frequencies of the respective groups in order not to produce variation between the numbers of droplet ejection actions performed by the groups. For example, the group selection is changed appropriately, in order to avoid bias to the nozzles 120A belonging to the first group only, or the nozzles 120B belonging to the second group only, or the nozzles 120C belonging to the third group only.

### <Description of Drive Voltage>

In the head 110 according to the present embodiment, the droplet ejection is controlled for the respective groups, and therefore it is possible to adjust the droplet ejection volume and the droplet ejection timing in the respective groups by modifying the waveforms of the drive voltage for the respective groups. Below, modification examples of the drive voltage waveform are described.

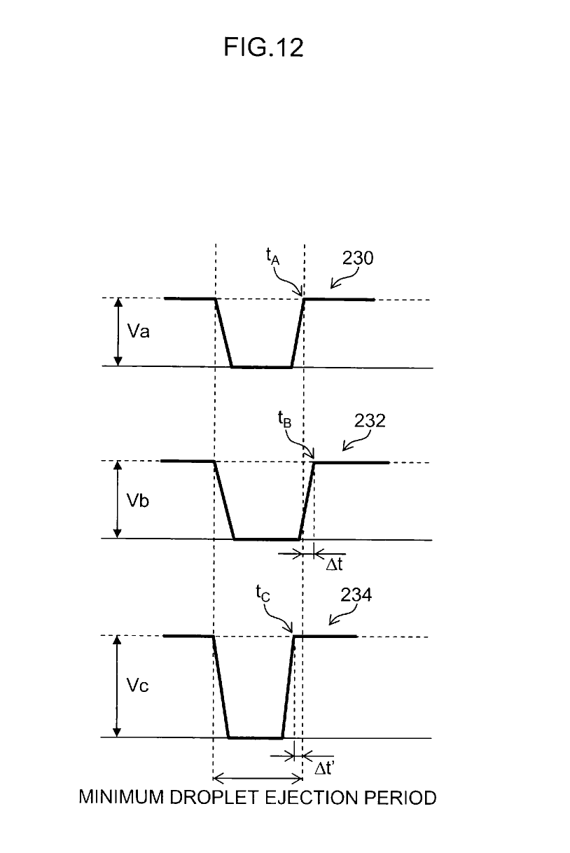

Drive voltages 230, 232 and 234 shown in FIG. 12 are embodiments of the drive voltages having waveforms to perform a “pull-push” operation of the piezoelectric element 123. For example, it is possible to use the different waveforms for the respective groups, in such a manner that the drive voltage 230 is used for the droplet ejection from the nozzles 120A belonging to the first group, the drive voltage 232 is used for the droplet ejection from the nozzles 120B belonging to the second group, and the drive voltage 234 is used for the droplet ejection from the nozzles 120C belonging to the third group.

The purpose of adjusting the waveforms for the respective groups is to reduce variation in the ejected droplet volumes, and to ensure uniform ejection stability for all of the nozzles. For example, if the liquid chambers 122 (see FIG. 7) are processed in group units by machine processing such as dicing, then there can be variation in the size of the liquid chambers 122, and the like, between the respective groups, and therefore it is necessary to adjust the drive voltage waveforms for the respective groups so as to avoid variation in the droplet volumes of the respective groups. If the nozzles 120 (see FIG. 7) are formed by laser processing in the nozzle plate 130 (see FIG. 7) which uses a non-metallic material, such as polyimide, then there can be variation in the size and shape, etc. of the nozzles 120, in the respective groups, and therefore it is necessary to adjust the drive voltage waveforms for the respective groups so as to avoid variation in the droplet ejection volumes of the respective groups.

The drive voltage 230 has a maximum voltage (maximum amplitude) Va, and the drive voltage 232 has a maximum voltage of Vb (>Va). The drive voltage 234 has a maximum voltage of Vc (>Vb). In this way, by changing the maximum values of the drive voltages for the respective groups, it is possible to change the droplet ejection volumes for the respective groups. It is possible to make the droplet ejection volume relatively large by making the maximum value of the drive voltage relatively large, and it is possible to make the droplet ejection volume relatively small by making the maximum value of the drive voltage relatively small. A concrete example of the composition in which the maximum values of the drive voltages are changed is one in which the head driver 184 shown in FIG. 11 includes a voltage adjustment unit in accordance with the groups assigned to the piezoelectric elements 123 (the nozzles 120). The ejection volume can be adjusted by adjusting the waveform of the drive voltage in this way.

Furthermore, by changing the pulse widths of the drive voltages (the “minimum droplet ejection period” shown in FIG. 12), it is possible to adjust ejection to suit resonance of the intrinsic frequency of the head 110 (see FIG. 7), which is a result of the shape of the liquid chambers, and the period of the drive waveform, and therefore improvement in the droplet ejection efficiency and improvement in the droplet ejection stability can be expected.

On the other hand, the drive voltage 232 has a delay time added to the drive voltage 230 in a range less than the minimum droplet ejection period, and the droplet ejection timing can be adjusted finely within the range less than the minimum droplet ejection period. More specifically, the application end timing t_{B} of the drive voltage 232 is delayed by Δt with respect to the application end timing t_{A} of the drive voltage 230, and therefore when the drive voltage 232 is applied, the droplet ejection timing is delayed by Δt compared to a case where the drive voltage 230 is applied. Similarly, the application end timing t_{A} of the drive voltage 230 is delayed by Δt′ with respect to the application end timing t_{c} of the drive voltage 234, and therefore when the drive voltage 230 is applied, the droplet ejection timing is delayed by Δt′ compared to a case where the drive voltage 234 is applied. By means of this composition, it is possible to change the droplet deposition density without changing the droplet deposition arrangement, and without changing the nozzles performing the droplet ejection.

Moreover, by changing the phases for the respective liquid chambers (for the respective nozzles) through applying the delay time, it is possible to correct variations in the ejection volume due to intrinsic variations (in the thickness, piezoelectric constant, Young's modulus, and so on) in the piezoelectric elements. A concrete example of the addition of the delay time is described in detail in “Description of droplet deposition arrangement in y direction” later.

By changing the waveform of the drive voltage with the addition of the delay time, variation in the resonance frequency of the head caused by the intrinsic variation of the piezoelectric elements is reduced, the variations in the droplet ejection efficiency between the respective nozzles are made uniform, and the droplet ejection stabilities of the respective nozzles are made uniform.

The “minimum droplet ejection period” indicated in FIG. 12 is the time of the trapezoid portion of the drive voltage 230, and is the time defined with the broken lines in the vertical direction. The relationship between the amplitude, pulse width and delay time of the drive voltage of each group can be changed appropriately in accordance with the droplet ejection conditions.

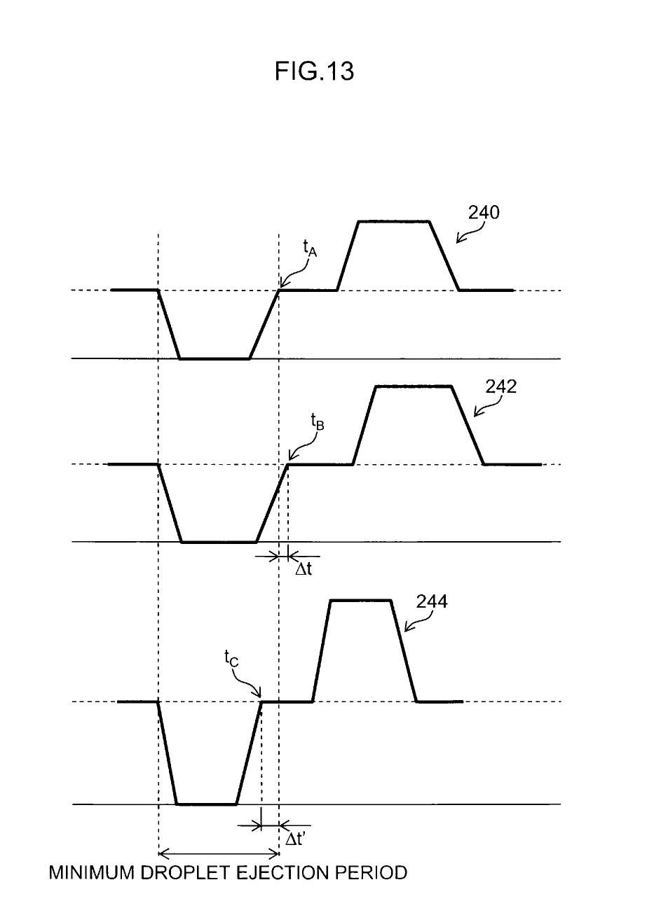

Drive voltages 240, 242 and 244 shown in FIG. 13 cause the piezoelectric elements 123 to operate in a direction which compresses the liquid chambers 122, and then cause the piezoelectric elements 123 to operate so as to expand the liquid chambers 122. The amplitudes, pulse widths and delay times of the drive voltages 240, 242 and 244 shown in FIG. 13 have a similar relationship to the drive voltages 230, 232 and 234 shown in FIG. 12, and in the drive voltages having these waveforms also, the waveforms can be changed for the respective groups.

It is also possible to change the drive voltage waveforms individually for the nozzles 120 or liquid chambers 122 belonging to the same group. In this mode, it is necessary to prepare the drive voltage waveforms for the respective nozzles (the respective liquid chambers), and a memory having a capacity corresponding to the number of nozzles is required. It is decided whether to prepare the waveforms for the respective groups or to prepare the waveforms for the respective nozzles, in accordance with the capacity of the memory in which the drive voltage waveforms are stored.

### <Description of Droplet Deposition Arrangement in x Direction>

The deposition arrangement (deposition pitch) of the droplets of the resist solution in the x direction is described below. In the description given below, a full line type of head is used, in which the nozzles are formed through a length corresponding to the entire width of the substrate 102.

As described above, when the droplet ejection is performed from the nozzles 120A belonging to the first group, the nozzles 120B belonging to the second group and the nozzles 120C belonging to the third group are idle, and when the droplet ejection is performed from the nozzles 120B belonging to the second group, the nozzles 120A belonging to the first group and the nozzles 120C belonging to the third group are idle. Moreover, when the droplet ejection is performed from the nozzles 120C belonging to the third group, the nozzles 120A belonging to the first group and the nozzles 120B belonging to the second group are idle.

More specifically, the minimum droplet deposition pitch P_{d} in the x direction is m times the minimum nozzle pitch in the x direction (where m is an integer not smaller than 3), and this is the minimum nozzle pitch Pₙ of each group. For example, if the minimum droplet deposition pitch in the x direction is 400 μm, then droplets having the x-direction diameter of approximately 50 μm are arranged discretely at a pitch of 400 μm. Moreover, it is also possible to regroup each of the groups into n groups (where n is a positive integer), and to set the minimum droplet deposition pitch to 400/n (μm).

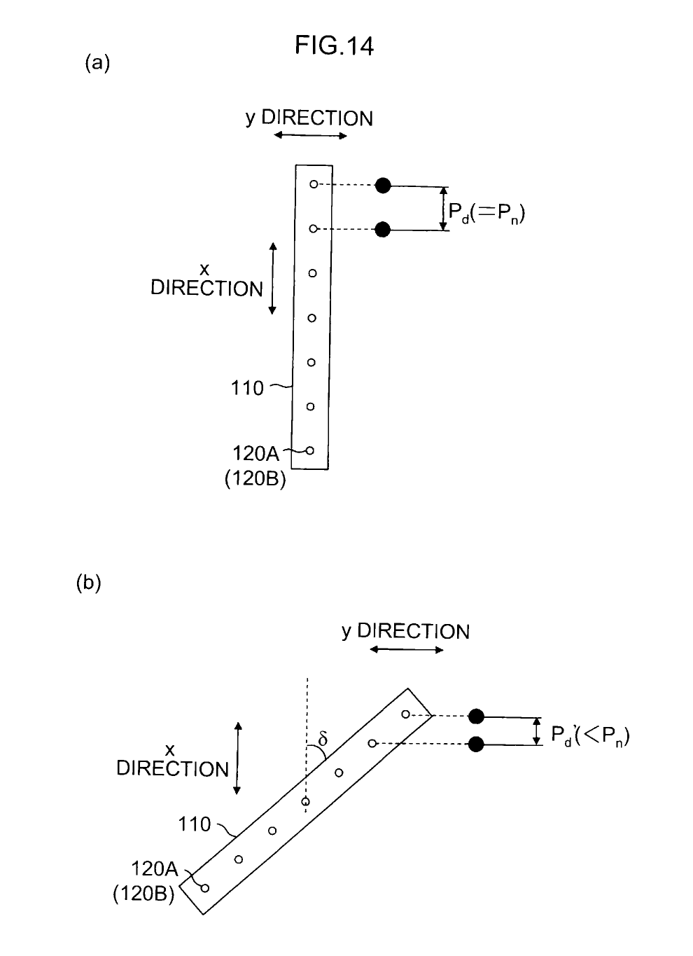

In the head 110 according to the present embodiment, it is possible to finely adjust the droplet deposition pitch in the range less than the minimum nozzle pitch Pₙ in the x direction for each group, and it is possible to accurately adjust the deposition density of the droplets in the x direction, without changing the nozzles performing the droplet ejection. FIG. 14 is a schematic drawing for showing a concrete example of the composition for finely adjusting the droplet deposition pitch in the x direction. The x direction droplet deposition pitch fine adjustment device described below is composed in such a manner that the head 110 is turned in a plane substantially parallel to the surface of the substrate 102 (see FIG. 6) onto which the droplets are deposited, so as to finely adjust the droplet deposition pitch in the x direction.

In the head 110 shown in part (a) of FIG. 14, only the nozzles 120A belonging to the first group (or the nozzles 120B of the second group only, or the nozzles 120C of the third group only) are depicted, and the nozzles 120A of the first group are arranged equidistantly at the minimum nozzle pitch Pₙ. In actual practice, the nozzles 120B of the second group and the nozzles 120C of the third group are arranged between the shown nozzles 120A. The nozzles 120B of the second group and the nozzles 120C of the third group are also arranged equidistantly at the minimum nozzle pitch Pₙ.

In this case, the standard droplet deposition pitch P_{d} in the x direction (which corresponds to W_{b} in part (a) of FIG. 3) is the same as the minimum nozzle pitch Pₙ in the x direction. As shown in part (b) of FIG. 14, when the head 110 is turned so as to form an angle of δ with respect to the x direction, the droplet deposition pitch in the x direction can be changed from P_{d} to P_{d}′ (=Pn×cos δ (where 0°<δ<45°)). The droplet deposition pitch in the x direction can be adjusted finely in the range less than the minimum nozzle pitch Pₙ, in each group, by means of the x direction droplet deposition pitch fine adjustment device thus composed. For example, if the droplet deposition pitch P_{d} before the fine adjustment is taken to be 400 μm, then when the head 110 is turned in such a manner that δ=28.9°, then the droplet deposition pitch P_{d}′ after the fine adjustment is approximately 350 μm.

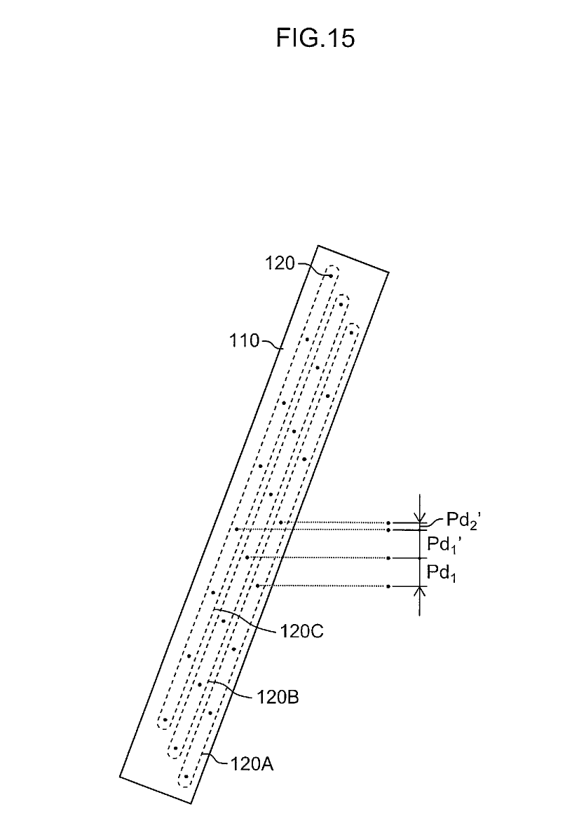

If the head 110 in which the nozzles 120 are obliquely arranged as shown in FIG. 8 is turned, then there are positions where the droplet deposition pitch after the fine adjustment is discontinuous. More specifically, when the nozzles 120 are obliquely arranged as shown in FIG. 8, there are positions where the droplet deposition pitch after the fine adjustment is P_{d1}′ and positions where the droplet deposition pitch after the fine adjustment is P_{d2}′ (<P_{d1}′), as shown in FIG. 15.

The head having this structure is able to perform droplet deposition onto prescribed droplet deposition positions specified in the perpendicular (square) grid shape, under conditions whereby no droplet ejection is performed from the adjacent nozzles at the same timing, but if it is attempted to finely adjust the droplet deposition positions by turning the head, then discontinuous points in the droplet deposition pitch arise. On the other hand, in the head 110 in which the droplet ejection is controlled for each of the groups, even if the droplet deposition positions are finely adjusted by turning the head, it is possible to perform droplet deposition onto the prescribed droplet deposition positions that have been specified.

If using the head 110 in which the nozzles 120 are obliquely arranged as shown in FIG. 15, a desirable mode is one in which the head 110 is controlled so as to perform droplet ejection using only the nozzles belonging to one group, in one scanning action of the substrate 102 with the head 110.

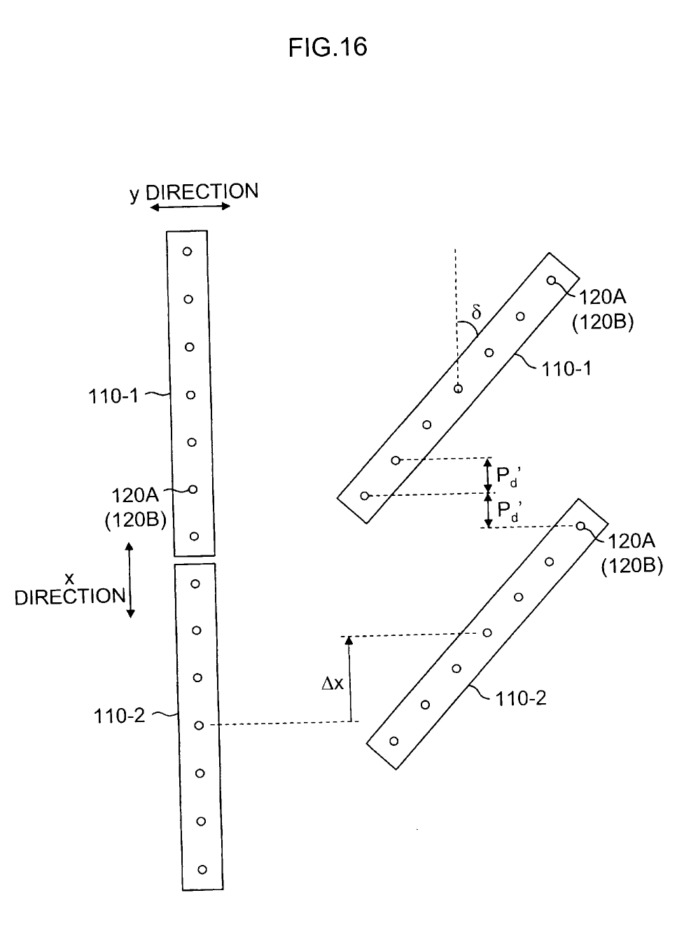

FIG. 16 is a diagram showing a schematic view of the composition of the x direction droplet deposition pitch fine adjustment device in a case where one long head is composed by joining together two (a plurality of) head modules 110-1 and 110-2 in the x direction. As well as turning the respective head modules 110-1 and 110-2, either of the head modules 110-1 and 110-2 is moved by Δx in the x direction in such a manner that the droplet deposition pitch after the fine adjustment in the joint section of the head modules 110-1 and 110-2 becomes P_{d}′. It is also possible to move both the head modules 110-1 and 110-2 in the x direction.

More specifically, in the mode where the long head is composed by joining together the plurality of head modules 110-1 and 110-2 in the x direction, then in addition to providing the turning mechanism for turning each of the head modules 110-1 and 110-2 in the x-y plane, an x direction movement mechanism is provided for adjusting the relative distance in the x direction between the adjacent head modules 110-1 and 110-2.

Although the mode shown in FIGS. 14 and 15 is one where the head 110 is turned on the turning axis passing through substantially the center of the head 110, it is also possible to turn the head 110 on a turning axis passing through the end portion of the head 110. A concrete example of the composition for turning the head 110 can be one which includes a motor (gear and motor) installed on the turning axis and a head supporting mechanism, which supports the head 110 turnably on the turning axis.

With the x direction droplet deposition pitch fine adjustment device having the above-described structure, when the x direction droplet deposition pitch P_{d} is finely adjusted, the y direction droplet deposition pitch is also changed, and it is therefore necessary to finely adjust also the y direction droplet deposition pitch in accordance with the amount of fine adjustment in the x direction. The fine adjustment of the droplet deposition pitch in the y direction can employ the method described below.

In the mode which employs the serial type head, the head 110 having the nozzles 120 arranged in the y direction performs the scanning action in the x direction, and therefore the x direction and the y direction should be exchanged in the description given above. In other words, it is possible to change the y direction dot pitch in a range less than the minimum nozzle pitch in the y direction.

### <Description of Droplet Deposition Arrangement in y Direction>

Concrete examples of the droplet deposition arrangement in the y direction and the fine adjustment of the droplet deposition pitch in the y direction are described below. If the full line type of head (see part (c) of FIG. 6) is used as the head 110, then droplet deposition is possible simultaneously at one droplet deposition timing, through the whole width in the x direction. By means of this structure, it is possible to deposit the droplets onto the whole area of the substrate 102, by relatively moving the head 110 and the substrate 102 once only.

If the substrate 102 is moved at a uniform speed in the y direction with respect to the head 110 which is fixed in position, then the minimum droplet deposition pitch in the y direction is “the minimum droplet ejection period”×“the movement speed of substrate 102”. Thus, it is possible to adjust the droplet deposition pitch in the y direction, in increments of m times the droplet ejection period (where m is a positive integer), without changing the nozzles performing the droplet ejection. If the movement speed of the substrate 102 is raised, the droplet deposition pitch in the y direction is increased, and if the movement speed of the substrate 102 is lowered, then the droplet deposition pitch in the y direction is reduced.

Moreover, the head 110 according to the present embodiment is provided with a droplet deposition pitch fine adjustment device for finely adjusting the droplet deposition pitch also in the y direction without changing the nozzles performing the droplet ejection, in a range of less than “the minimum droplet ejection period”×“the movement speed of substrate”. The drive voltage for finely adjusting the droplet deposition pitch in the y direction can employ the drive voltages 230, 232, 234 to which the delay time Δt has been added as shown in FIG. 12, or the drive voltages 240, 242, 244 to which the delay time Δt′ has been added as shown in FIG. 13. By finely adjusting the droplet deposition pitch in the y direction in this way, it is possible to change the phase of the drive voltage by finely adjusting the drive timings of the piezoelectric elements 123 (see FIG. 7), and variation in the droplet ejection characteristics due to processing variations in the liquid chambers, and the like, and variations in the piezoelectric elements, can be suppressed.

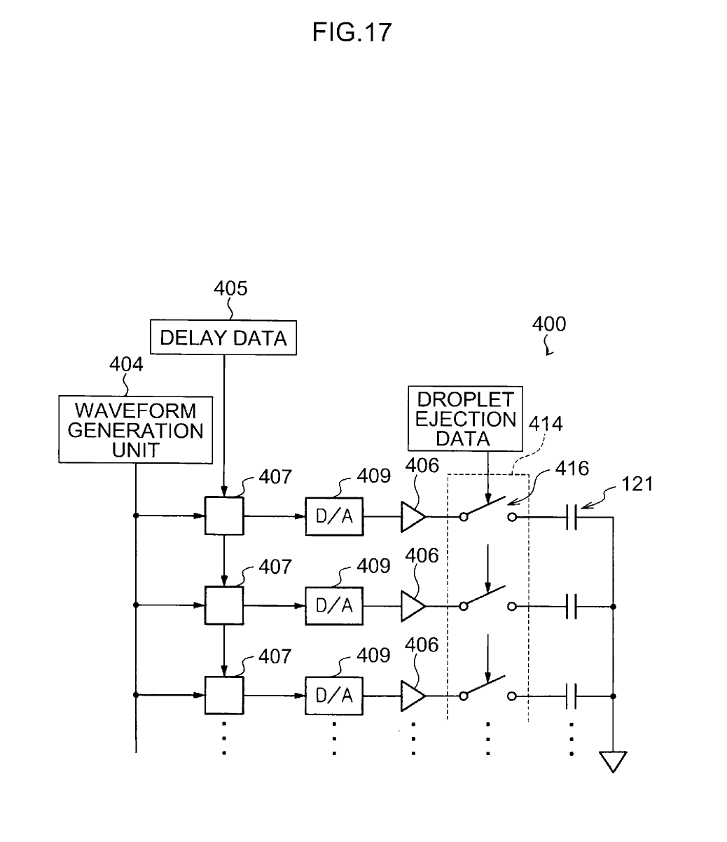

FIG. 17 is a block diagram showing the composition for adding the delay time Δt to the standard drive voltage. The drive signal generation unit 400 shown in FIG. 17 includes: a waveform generation unit 404, which generates a drive waveform for each nozzle 120; a delay data generation unit 405, which calculates, for each nozzle, a delay time Δt for use when changing the droplet deposition pitch in the x direction; an adder unit 407, which adds the delay time Δt generated by the delay data generation unit 405, to the drive waveform data; a D/A converter 409, which converts drive waveform data in a digital format to an analog format; and an amplifier unit 406, which performs voltage amplification processing and current amplification processing on the drive waveform in an analog format.

When the piezoelectric elements 123 corresponding to the nozzles are operated by turning on and off switching elements 416 of a switching IC 414 on the basis of the droplet ejection data, droplets of resist solution are ejected from desired nozzles.

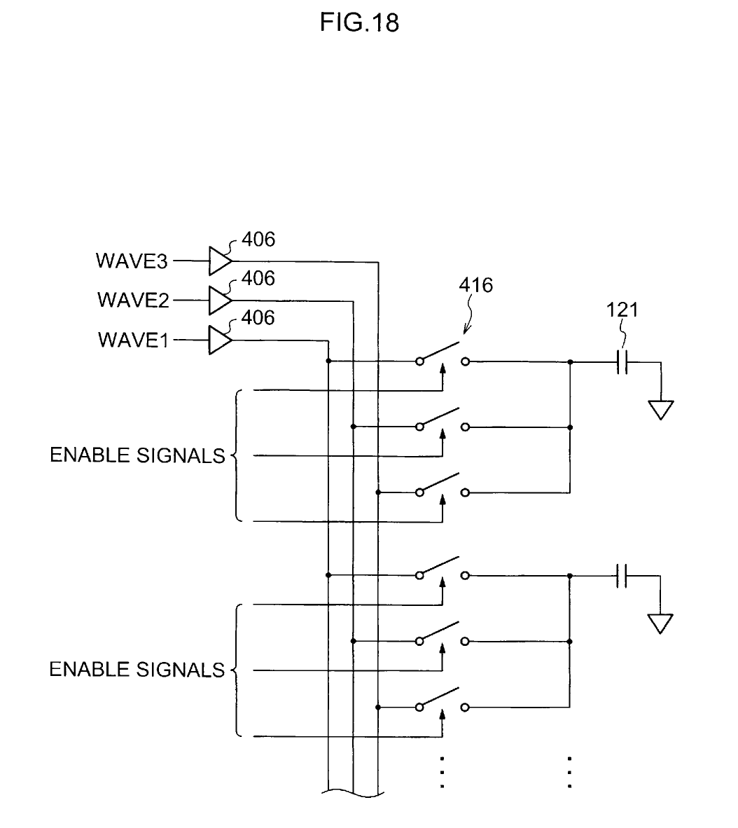

Furthermore, it is possible to adopt a composition in which a plurality of analog waveforms (WAVE 1 to 3) are prepared as shown in FIG. 18, and one of the analog waveforms is selected by an enable signal. This composition is able to operate as the y direction droplet deposition pitch fine adjustment device, independently of the x direction droplet deposition fine adjustment device.

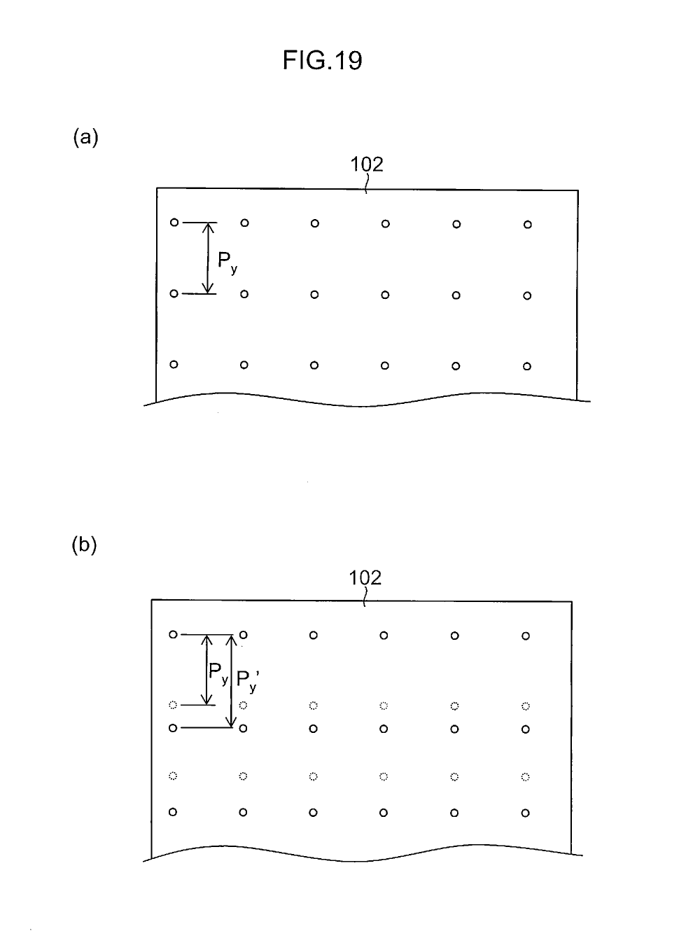

Part (a) of FIG. 19 shows droplet deposition positions on the substrate 102 before the fine adjustment of the y direction droplet deposition pitch, and part (b) of FIG. 19 shows droplet deposition positions on the substrate 102 after the fine adjustment of the y direction droplet deposition pitch. As shown in FIG. 19, P_{y}<P_{y}′<2×P_{y}, and the y direction droplet deposition pitch P_{y}′ after the fine adjustment is adjusted due to the addition of the delay time in the range less than the y direction droplet deposition pitch P_{y}. The droplet deposition positions indicated with the dotted lines in part (b) in FIG. 19 show the droplet deposition positions before the fine adjustment as shown in part (a) of FIG. 19.

The above-described fine adjustments of the droplet deposition pitches in the x direction and the y direction are carried out on the basis of the data about the arrangement (application pattern) of the resist solution and the properties of the resist solution, such as the volatility thereof. More specifically, if a greater amount of the droplets than standard is required, in accordance with the droplet deposition data for the resist solution which corresponds to the fine pattern to be formed on the substrate, then the droplet deposition pitch is changed so as to become smaller, and hence the resist solution is applied more densely. On the other hand, if a smaller amount of the droplets than standard is required, then the droplet deposition pitch is changed so as to become larger, and the resist solution is applied more sparsely. It is also possible to change the droplet ejection volume of the resist solution as described above, in accordance with the change in the droplet deposition pitch. Furthermore, it is desirable that the droplet deposition pitches in the x direction and the y direction are adjusted finely on the basis of the droplet deposition arrangement which takes account of anisotropy of the wetting and spreading due to the mold pattern, as described with reference to FIGS. 3 and 4.

### <Description of Determination of Droplet Ejection>

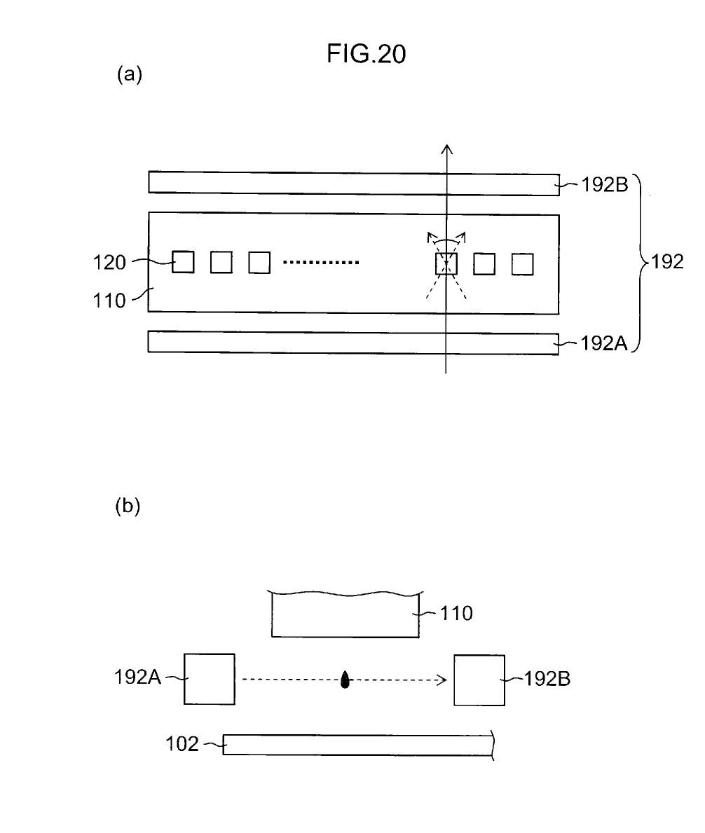

The determination of the droplet ejection by the head 110 is described below. As shown in FIG. 20, the head 110 according to the present embodiment is provided with the sensor 192 for determining the state of droplet ejection. Part (a) of FIG. 20 is a diagram showing a schematic view of the positional relationship of the head 110 and the sensor 192, and part (b) of FIG. 20 shows the head 110 and the sensor 192 depicted in part (a) of FIG. 20, as viewed from the end portion of the head 110 in the breadthways direction.

As shown in part (a) of FIG. 20, the light emitting unit 192A is arranged on one side of the head 110 in the breadthways direction, and the light receiving unit 192B is arranged on the other side of the head 110. The nozzles 120 arranged in the head 110 have the apertures which have the substantially square planar shape as viewed from the droplet ejection surface of the head 110, and the direction of observation of the sensor 192 (as indicated with the solid-line arrow) forms an angle of approximately 45° with respect to the diagonals of the square shape (as indicated with the dashed-line arrows).

In the nozzles having the substantially square shaped apertures which are employed in the present embodiment, the corner angles are characteristic points which means that flight deviations occur in the directions of the diagonals, and therefore by observing the droplet in the direction forming the angle of approximately 45° with respect to the directions in which the flight deviations occur (in other words, the directions of the diagonals), and by analyzing the determination signal thus obtained, it is possible to ascertain the speed of flight, the flight deviation and the volume of the droplet.

When this information relating to the droplet ejection characteristics has been obtained, it is possible to suppress variation in the droplet ejection characteristics by changing the drive voltage waveform (amplitude, pulse width, phase, etc.) on the basis of this information, and uniform ejection characteristics are ensured.

### <Description of Nozzle Plate>

<Method for Fabricating Nozzle Plate>

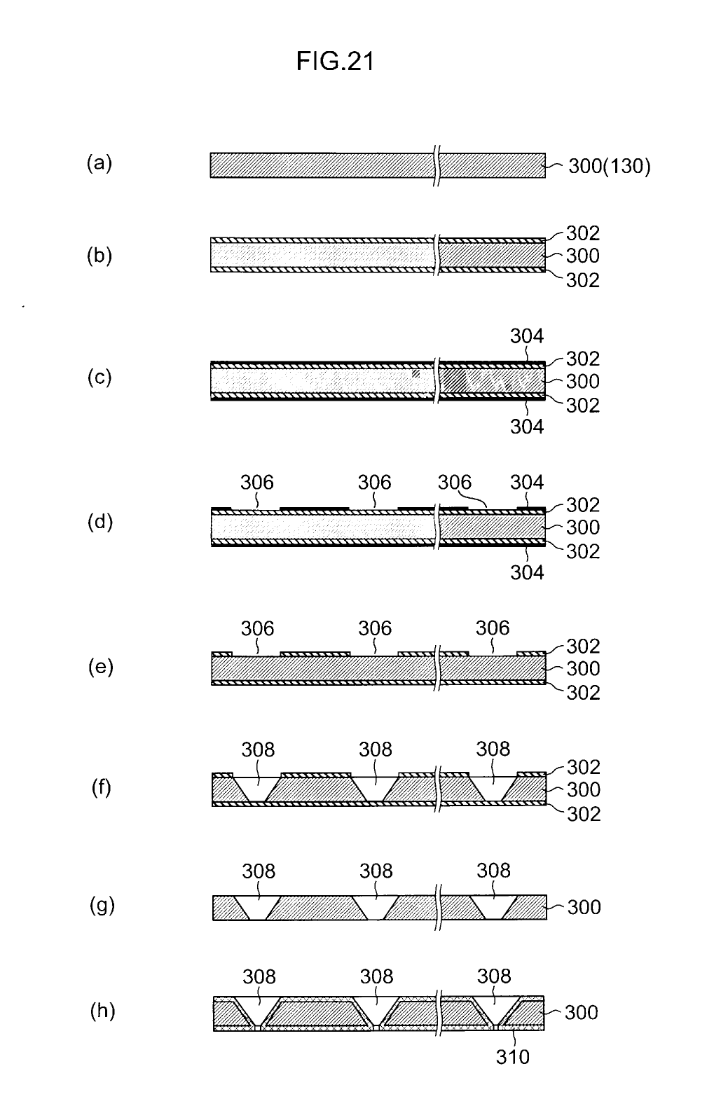

A method of fabricating the nozzles 120 having the substantially square shaped apertures as shown in FIG. 8 and so on, is described below. FIG. 21 is an illustrative diagram showing a schematic view of steps for forming the nozzle plate 130 having the nozzles 120.

The nozzle plate 130 (see part (a) of FIG. 7) employed in the head 110 according to the present embodiment is formed by applying an anisotropic etching process to a monocrystalline silicon wafer. The silicon wafer 300 shown in part (a) of FIG. 21 is obtained by a polishing process on the P type or N type surface with the crystal orientation (100). As shown in part (b) of FIG. 21, the surface of the silicon wafer 300 is subjected to oxidization processing at a treatment temperature of 1000° C., thereby forming an oxide film (SiO₂) 302 having a thickness of 4500 Å.

Thereupon, as shown in part (b) of FIG. 21, a resist layer 304 is formed on the oxide film 302, and an aperture pattern 306 is exposed on the resist layer 304 and developed (part (d) of FIG. 21). Then, the oxide film 302 of the aperture pattern 306 is removed, and the resist layer 304 is removed (part (e) of FIG. 21). The silicon wafer 300 from which the resist layer 304 and the oxide film 302 of the aperture pattern 306 have been removed is immersed in an etching solution at 100° C. to 120° C., and holes 308 having a shape in which the opening surface area decreases from one surface toward the other surface (in other words, having a substantially triangular cross-sectional shape) are formed (part (f) of FIG. 21).

Thereupon, the oxide film 302 is removed (part (g) of FIG. 21), and oxidization processing is then performed to form an oxide film 310 inside the holes 308 and on the surface of the silicon wafer 300 (part (h) of FIG. 21).

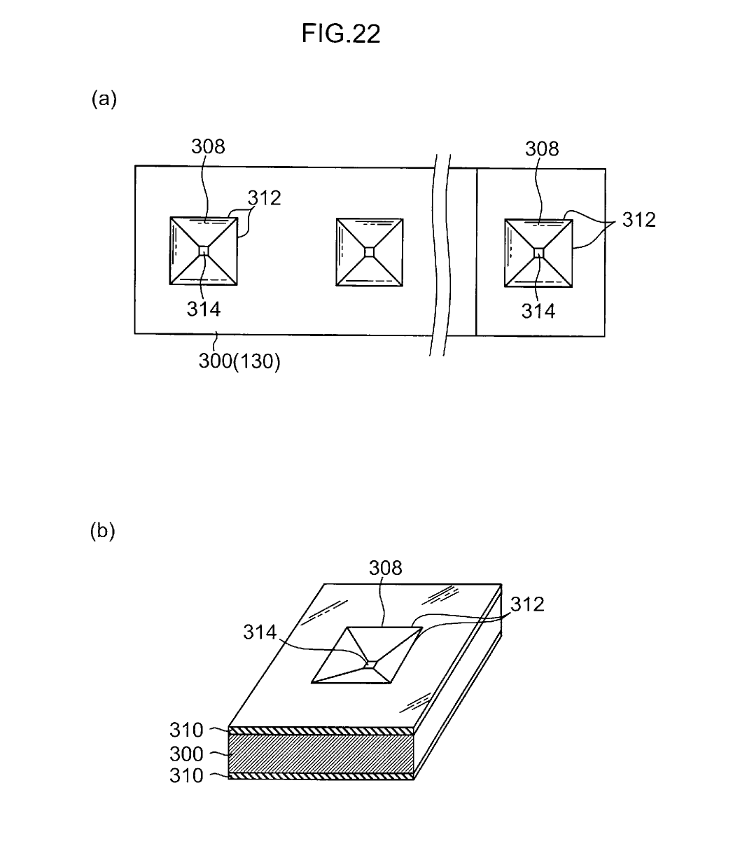

Part (a) of FIG. 22 is a plan diagram, as viewed from the interior side, of the nozzles 120 formed by using the above-described fabricating method, and part (b) of FIG. 22 is a partial enlarged diagram (perspective diagram) of part (a) of FIG. 22. As shown in FIG. 22, the apertures 312, 314 of the holes 308 which are to become the nozzles 120 (see FIG. 8, etc.) have the substantially square shape. The apertures 314 form the apertures of the nozzles 120 when attached to the head 110. As shown in FIG. 22, the holes 308 which are to form the nozzles 120 have a truncated substantially quadrangular pyramid.

The nozzle plate 130 fabricated by using this fabricating method is formed with the desirable nozzles 120 which are free of variations in size or shape.

### <Description of Liquid Repellent Treatment (Liquid Repellent Film)>

A liquid repellent treatment (liquid repellent film) for the nozzle plate is described below. The droplet ejection surface of the nozzle plate 130 (see part (a) of FIG. 7) is subjected to a liquid repellent treatment having prescribed properties, in order to ensure the stability of ejection.

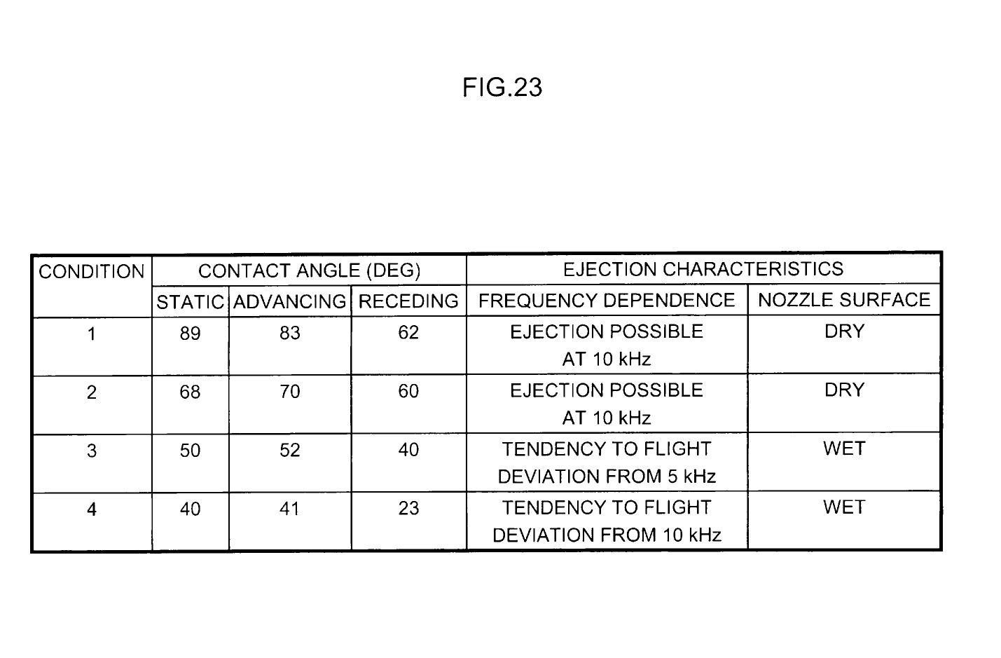

FIG. 23 shows experimental data indicating differences in ejection characteristics due to the characteristics of the liquid repellent films formed on the nozzle plates 130. The evaluation experiment used to obtain this data involves observing the state of ejection while forcibly degrading the liquid repellent film formed on the prescribed inkjet head by oxygen plasma and thereby changing the contact angle on the liquid repellent film. The contact angle is measured by a tangent method or an expansion and contraction method, using a contact angle meter FTA 1000 (manufactured by FTA).

In FIG. 23, the “static” column indicates the values of the static contact angle, and these values are found by the tangent method. More specifically, a resist composition was dripped onto the nozzle plate 130, the outline shape of the image of the droplet on the nozzle plate 130 was assumed to be a portion of a circle and the center of this circle was determined, and the angle formed between a tangent to the circle and a straight line was specified as the static contact angle. The “advancing” column indicates the values of the advancing contact angle, and the “receding” column indicates the values of the receding contact angle. These values are contact angles determined by the expansion and contraction method. When a droplet in contact with the solid surface was caused to swell, the contact angle reached when the contact angle had stabilized was taken as the advancing contact angle, and when a droplet in contact with the solid surface was caused to contract by being sucked, the contact angle reached when the contact angle had stabilized was taken as the receding contact angle.

As shown in FIG. 23, under Conditions 1 and 2, a good droplet ejection state was observed at a droplet ejection frequency of 10 kHz, and the nozzle surface (ejection surface) was in a dry state. On the other hand, under Conditions 3 and 4, flight deviation occurred at droplet ejection frequencies of 5 kHz and 10 kHz, and the whole of the nozzle surface was wetted with the droplets (liquid).

It is possible to use a fluororesin as the liquid repellent film. As the fluororesin material, it is possible to use various commonly known fluororesins, such as a fluorocarbon resin which includes “—CF₂-” in a main chain and “—CF₃” in an end group, a fluorosilicone resin which includes “—SiF₂-” in a main chain and “—SiF₃” in an end group, and a hydrofluorocarbon resin and a hydrofluorosilicone resin, and the like, in which some of fluorine atoms in the fluorocarbon resins or fluorosilicone resins are substituted with hydrogen atoms.

More specifically, it is possible to use, for example, fluororesins, such as PTFE (polytetrafluoroethylene), PFA (tetrafluoroethylene-perfluoroalkyl vinyl ether copolymer), FEP (tetrafluoroethylene-hexafluoropropylene copolymer), ETFE (tetrafluoroethylene copolymer), and the like. Furthermore, of these, PTFE can be cited as a particularly desirable example.

Furthermore, for the liquid repellent film, it is possible to use precursor molecules, containing a carbon chain, one end of which terminates with a “—CF₃” group and a second end of which terminates with a “—SiCl₃” group. As a suitable precursor material for application to a silicon surface, it is possible to cite: tridecafluoro-1,1,2,2-tetrahydrooctyltrichlorosilane (FOTS) and 1H,1H,2H,2H-perfluorodecyltrichlorosilane (FDTS).

If deterioration occurs in the liquid repellent film, then the droplet ejection characteristics change as shown in FIG. 23, and it is possible to provide a device for periodically ascertaining the state of the liquid repellent film, and mask processing, or the like, is carried out by software so as to disable use of the nozzle group including the nozzle where the deterioration of the liquid repellent film has been observed.

According to the nanoimprint system 100 which is composed as described above, since the nozzles 120 arranged in the head 110 are formed into the groups and the droplet ejection is controlled for each of the groups, then it is possible to control individual differences between the groups (variation in the droplet ejection characteristics of the nozzles, variation in the piezoelectric elements), the fill properties are improved, and the non-uniformities in the thickness of the remaining film (residue) do not occur as a result of the individual differences. Consequently, the thickness of the film formed by the deposited droplets is stabilized, and therefore the conditions in the substrate etching step are stabilized and a desirable fine pattern is formed on the substrate.

Furthermore, since the composition in which discrete resist solution droplets are arranged in the x direction substantially parallel to the arrangement direction of the nozzles and the y direction substantially perpendicular to the arrangement direction of the nozzles is equipped with the composition for finely adjusting the droplet deposition pitch in either the x direction or the y direction, or in both the x direction and the y direction, in the range less than the minimum droplet deposition pitch, then it is possible to precisely change the droplet deposition density of the droplets in simple matter in accordance with the droplet deposition pattern and the properties of the solution, such as the volatility.

Moreover, since the counter 194 for counting the number of droplet ejection actions of each group is provided, and the number of droplet ejection actions of each group is counted, the group to perform droplet ejection being selected in accordance with these count results, then increase in the droplet ejection frequency of a particular group is prevented and the durability of the head 110 is improved.

Furthermore, since the sensor 192 for determining the droplet ejection state is provided, and the flight deviation of the droplets and abnormalities in the droplet volume can be ascertained on the basis of the determination results, then it is possible to select the group in accordance with abnormalities in the state of droplet ejection, and hence the droplet ejection characteristics of the head are stabilized.

In the present embodiment, the nanoimprint system is considered in which the fine pattern is formed by the resist solution on the substrate, but the above-described configuration can be also implemented as an integral device (nanoimprint device). Further, it is also possible to configure a liquid application device in which a solution is discretely disposed on a substrate by an inkjet method.

### Application Example

An application example of the present invention is described below. In the above-described embodiment, the example is given in which a nanoimprint method is used as a method for forming a fine pattern on a substrate; however, it is also possible to form a quartz mold using a nanoimprint method.

### <Fabrication of Quartz Mold>

A quartz mold can be fabricated by using the fine pattern forming method for a quartz substrate as shown in FIG. 1. In other words, it is possible to fabricate a quartz mold by using the nanoimprint system and method according to the above-described embodiment. When fabricating the quartz mold, it is suitable to use a Si mold for which the method of fabrication is described below.

### <Fabrication of Si Mold>

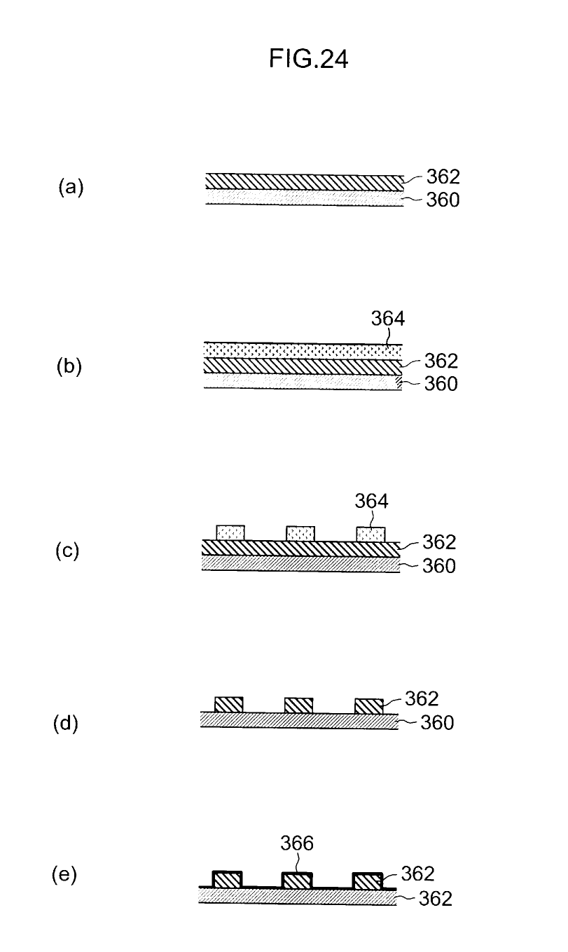

The Si mold used in the above-described embodiment can be fabricated by the procedure shown in FIG. 24. First, a silicon oxide film 362 is formed on a Si base material 360 shown in part (a) of FIG. 24, and a photoresist solution, such as a novolac resin, acrylic resin, or the like, is applied by spin coating, or the like, as shown in part (b) of FIG. 24, thereby forming a photoresist layer 364. Thereupon, as shown in part (c) of FIG. 24, the Si base material 360 is irradiated with laser light (or electron beam), thereby exposing a prescribed pattern on the surface of the photoresist layer 364.

Subsequently, as shown in part (d) of FIG. 24, the photoresist layer 364 is developed, the exposed portions are removed, and selective etching is carried out by RIE, or the like, by using the pattern in the photoresist layer after the removal as a mask and thereby obtaining a Si mold having a prescribed pattern.

The mold used in the nanoimprint method according to the present invention can employ a separating process in order to improve the detachment properties between the light-curable resin and the mold surface. For a mold of this kind, it is suitable to use a mold which has been treated with a silicon-containing or fluorine-containing silane coupling agent, such as Optool DSX manufactured by Daikin Industries Ltd., or Novec EGC-1720 manufactured by Sumitomo 3M Ltd., etc. Part (e) of FIG. 24 shows a Si mold on which a mold separating layer 366 has been formed.

<Description of Light-Curable Resin Solution>

Next, a resist composition (hereinafter also referred simply to as “resist”) is described in detail as one example of a light-curable resin solution which is employed in the nanoimprint system described in the present embodiment.

The resist composition is a curable composition for imprint which contains, at least, a surfactant including fluorine of one or more types (a fluorine-containing surfactant), and a photo-polymerization initiator I.

The resist composition can include a monomer component having one or more functions which includes a polymerizable functional group with the object of improving etching resistance, either by achieving a cross-linking function due to the inclusion of a polyfunctional polymerizable group, or by raising the carbon density, or raising the total amount of coupling energy, or suppressing the content ratio of sites having a high electronegativity, such as O, S, N, which are included in the resin after curing, and furthermore, according to requirements, the resist composition can include a coupling agent with the substrate, or a volatile solvent, and an anti-oxidant, and the like.

For the coupling agent with the substrate, it is possible to use similar materials to the above-described adhesion treatment agent for the substrate. The content ratio of the coupling agent can be a level ensuring the presence thereof at the interface between the substrate and the resist layer, and can be not more than 10 wt %, desirably, not more than 5 wt %, more desirably, not more than 2 wt %, and most desirably, not more than 0.5 wt %.

From the viewpoint of inclusion of a solid component (component remaining after the volatile solvent component has been removed) contained in the resist composition into the pattern formed on the mold 112 (see FIG. 6) and wetting and spreading ability on the mold 112, the viscosity of the solid component of the resist composition is set desirably to not more than 1000 mPa·s, more desirably, to not more than 100 mPa·s and even more desirably to not more than 20 mPa·s. However, when using an inkjet system, then desirably, the viscosity is not more than 20 mPa·s at room temperature, or if the temperature can be controlled in the head during ejection, then within this temperature range, and furthermore, the surface tension of the resist composition is in a range of not less than 20 mN/m and not more than 40 mN/m, or in a range of not less than 24 mN/m and not more than 36 mN/m from the viewpoint of ensuring the droplet ejection stability of the inkjet action.

<Polymerizable Compound>

The polymerizable compound which is the main component of the resist composition is the polymerizable compound having a fluorine content ratio in the compound represented by the formula [Math. 2] below is not more than 5%, or which contains substantially no fluoroalkyl groups or fluoroalkyl ether groups.

Fluorine Content Ratio={[(Number of Fluorine Atoms in Polymerizable Compound)×(Atomic Weight of Fluorine Atom)]/(Molecular Weight of Polymerizable Compound)}×100 [Math. 2]

The polymerizable compound is desirably one which has good quality in terms of the accuracy of the pattern after curing, and the etching resistance, and so on. Such polymerizable compound desirably contains a polyfunctional monomer which becomes a polymer having a three-dimensional structure due to cross-linking upon polymerization, and the polyfunctional monomer desirably has at least one bivalent or trivalent aromatic group.

In the case of the resist having the three-dimensional structure after curing (polymerization), the shape maintaining properties after the curing process are good, and plastic deformation of the pattern due the stress applied to the resist during separation from the mold becoming concentrated in a particular area of the resist structure, as a result of the adhesive force between the mold and the resist, is suppressed.

However, if the ratio of the polyfunctional monomer which becomes the polymer having the three-dimensional structure after polymerization, or the density of the sites which form three-dimensional cross-links after polymerization, is raised, then the Young's modulus after curing becomes greater, the deformability declines, the flexibility of the film worsens, and there is a concern that breaking becomes liable to occur during separation of the mold. In particular, in a mode where a pattern having a pattern size of not more than a width of 30 nm and a pattern aspect ratio of not less than 2 is formed to a remaining thickness of not more than 10 nm, if formation over a broad area, such as a hard disk pattern or a semiconductor pattern, is attempted, there is considered to be a high probability that detachment or distortion of the pattern will occur.

Consequently, it has been discovered that the polyfunctional monomer is contained in the polymerizable compound at a ratio of desirably not less than 10 wt %, more desirably, not less than 20 wt %, even more desirably, not less than 30 wt %, and most desirably, not less than 40 wt %.

Furthermore, it has been discovered that the cross-linking density represented by the formula [Math. 3] below is desirably not less than 0.01/nm² and not greater than 10/nm², more desirably not less than 0.1/nm² and not greater than 6/nm², and most desirably not less than 0.5/nm² and not greater than 5.0/nm². The cross-linking density of the composition is found by determining the cross-linking density of each molecule and then finding the weight-averaged value, or by measuring the density of the composition after curing, and using the weight-averaged values of Mw and (Nf−1) and the then respectively finding weight-averaged values for Mw and (Nf−1) by the formula [Math. 3] below:

$$Da = \frac{Na \times Dc}{Mw} \times ( Nf - 1 ) . \qquad [ Math . 3 ]$$

Here, Da is the cross-linking density of one molecule, Dc is the density after curing, Nf is the number of acrylate functional groups contained in one molecule of the monomer, Na is the Avogadro constant, and Mw is the molecular weight.

There are no particular restrictions on the polymerizable functional groups of the polymerizable compound, but a methacrylate group and an acrylate group are desirable, and an acrylate group is more desirable.

The dry etching resistance can be evaluated by the Onishi parameter and the ring parameter of the resist composition. The smaller the Onishi parameter and the larger the ring parameter, the better the dry etching resistance of the resist. In the present invention, the resist composition has an Onishi parameter of not more than 4.0, desirably, not more than 3.5, more desirably, not more than 3.0, and furthermore, the resist composition has a ring parameter of not less than 0.1, desirably, not less than 0.2, and more desirably, not less than 0.3.

The above-mentioned parameters are determined as average values for the whole of the resin composition in respect of the constituent materials apart from the volatile solvent components which constitute the resist composition, based on the weight ratios in the composition and the material parameter values calculated using the calculation equation described below on the basis of the structural formulas. Therefore, it is desirable that the polymerizable compound which is the main component of the resist composition is selected by taking account of the other components of the resist composition and the above-mentioned parameters.

Onishi parameter=(total number of atoms in compound)/{(number of carbon atoms in compound)−(number of oxygen atoms in compound)}

Ring parameter=(mass of carbon forming ring structure)/(total mass of compound)

The polymerizable compound can be one of the polymerizable monomers given below, or an oligomer obtained by polymerizing several of these polymerizable monomers. From the viewpoint of pattern forming characteristics and etching resistance, it is desirable to include a polymerizable monomer (Ax) and at least one or more type of the compounds described in paragraphs 0032 to 0053 of Patent Literature 3 (PTL 3).

<Polymerizable Monomer (Ax)>

Polymerizable monomer (Ax) is represented by General Formula (I) in [Chem. 1] below.

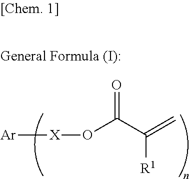

In the General Formula (I) shown in [Chem. 1] above, Ar represents a bivalent or trivalent aromatic group which can have a substitute group, X represents a single bond or an organic linking group, R¹ represents an alkyl group which can have a hydrogen atom or a substitute group, and n represents 2 or 3.

In General Formula (I) described above, when n=2, Ar is a divalent aromatic group (i.e., an arylene group), and when n=3, Ar is a trivalent aromatic group. Possible examples of the arylene group are a hydrocarbon type arylene group, such as a phenylene group or a naphthylene group, or a heteroarylene group having indole, carbazole, or the like, as a linking group; a hydrocarbon type arylene group is desirable, and a phenylene group is more desirable from the viewpoint of viscosity and etching resistance. The arylene group can have a substitute group, and a desirable substitute group can be: an alkyl group, an alkoxyl group, a hydroxyl group, a cyano group, an alkoxycarbonyl group, an amide group, or a sulfonamido group.

Possible examples of the organic linking group in X are an alkylene group, an arylene group and an aralkylene group, which can include a hetero atom in the chain. Of these, an alkylene group or an oxyalkylene group are desirable, and an alkylene group is more desirable. For X, a single bond or an alkylene group are especially desirable.

R¹ is desirably a hydrogen atom or a methyl group, and more desirably, is a hydrogen atom. If R¹ has a substitute group, then there are no particular restrictions on a desirable substitute group, but it is possible to cite a hydroxyl group, a halogen atom (excluding fluorine), an alkoxy group, and an acyloxy group as examples. n is 2 or 3, and desirably 2.

The polymerizable monomer (Ax) is desirably a polymerizable monomer represented by the General Formula (I-a) or the General Formula (I-b) shown in [Chem. 2] below, from the viewpoint of reducing the viscosity of the composition.

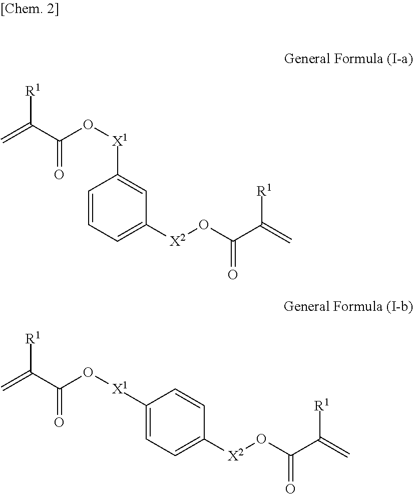

In the above General Formulas (I-a) and (I-b), X¹ and X² independently represent alkylene groups which can include a single bond or a substitute group having 1 to 3 carbon atoms, and R¹ represents a hydrogen atom or an alkyl group which can include a substitute group.

In General Formula (I-a), the aforementioned X¹ is desirably a single bond or a methylene group, and is more desirably a methylene group, from the viewpoint of reducing viscosity. A desirable range for X² is the same as the desirable range for X¹ above.

R¹ is the same as R¹ in General Formula (I) described above, and the desirable range therefor is also the same. If the polymerizable monomer (Ax) is a liquid at 25° C., then this is desirable, since the occurrence of foreign material can be suppressed when the added amount is increased. The viscosity at 25° C. of the polymerizable monomer (Ax) is desirably less than 70 mPa·s, from the viewpoint of the pattern forming properties, and more desirably, not more than 50 mPa·s, and especially desirably, not more than 30 mPa·s.

Specific examples of the desirable polymerizable monomers (Ax) are shown in [Chem. 3] below. R¹ herein has the same meaning as R¹ in General Formula (I). From the viewpoint of curability, it is desirable that R¹ is a hydrogen atom.

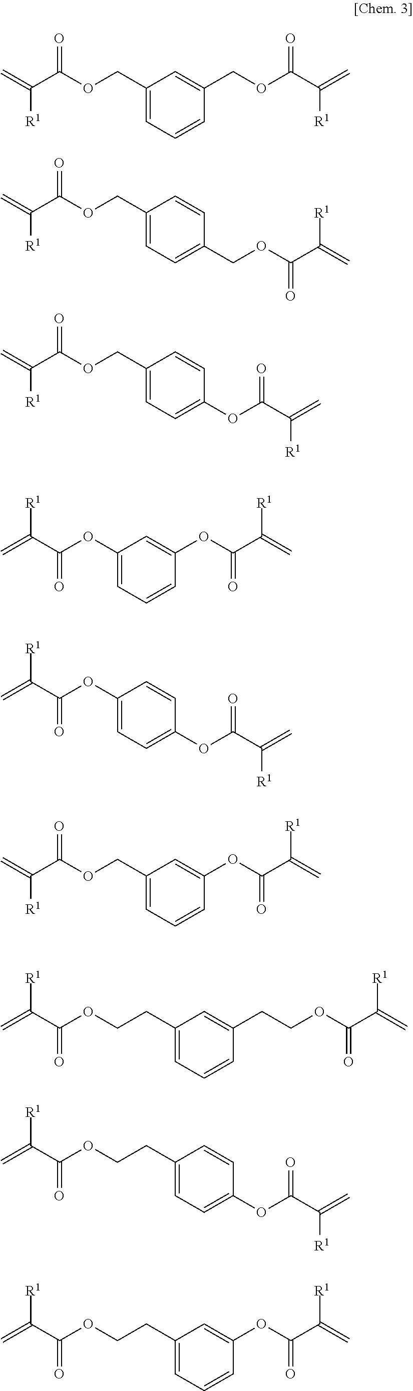

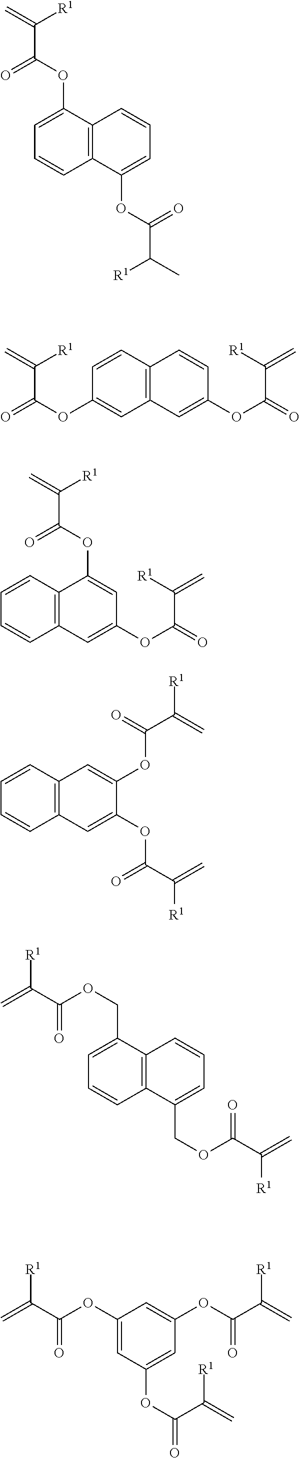

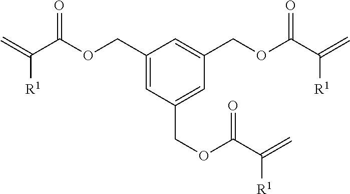

Of these, the compounds shown in [Chem. 4] below are liquids at 25° C., and also have low viscosity and even better curing properties, and are therefore especially desirable.

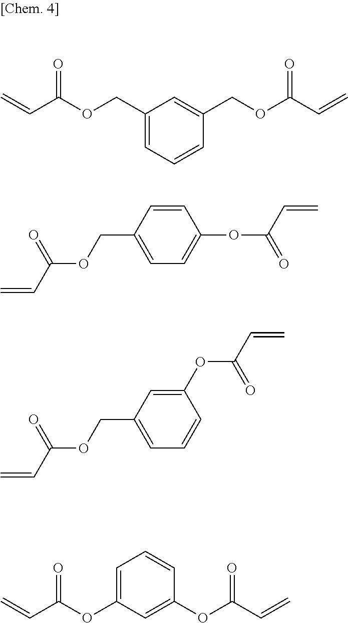

In the resist composition, from the viewpoint of achieving good viscosity of the resin, dry etching resistance, compatibility with imprint, curing properties, and the like, it is desirable to make combined use of the polymerizable monomer (Ax) and another polymerizable monomer which is different to the polymerizable monomer (Ax) described below, according to requirements.

<Further Polymerizable Monomers>

Possible examples of a further polymerizable monomer are: polymerizable unsaturated monomers having 1 to 6 ethylenic unsaturated bond-containing groups; compounds having an oxirane ring (epoxy compound); vinyl ether compounds; styrene derivatives; compounds having a fluorine atom; or propenyl ethers or butenyl ethers, or the like, and from the viewpoint of curing properties, polymerizable unsaturated monomers having 1 to 6 ethylenic unsaturated bond-containing groups are desirable.

Of these further polymerizable monomers, from the viewpoint of compatibility with imprint and dry etching resistance, curing properties, viscosity, and the like, it is more desirable to include a compound as described in paragraphs 0032 to 0053 of the description of Patent Literature 3. Below, polymerizable unsaturated monomers having 1 to 6 ethylenic unsaturated bond-containing groups (1 to 6-functional polymerizable unsaturated monomers) which can also be included are described further.

Firstly, specific examples of a polymerizable unsaturated monomer (monofunctional polymerizable unsaturated monomer) which has one group containing an ethylenic unsaturated bond are: 2-acryloyloxy ethyl phthalate, 2-acryloyloxy 2-hydroxy ethyl phthalate, 2-acryloyloxy ethyl hexahydro phthalate, 2-acryloyloxy propyl phthalate, 2-ethyl-2-butyl propane diol acrylate, 2-ethyl hexyl(meth)acrylate, 2-ethyl hexyl carbitol(meth)acrylate, 2-hydroxy butyl(meth)acrylate, 2-hydroxy ethyl(meth)acrylate, 2-hydroxy propyl(meth)acrylate, 2-methoxy ethyl(meth)acrylate, 3-methoxy butyl(meth)acrylate, 4-hydroxy butyl(meth)acrylate, acrylic acid dimer, benzyl(meth)acrylate, 1- or 2-naphthyl(meth)acrylate, butane diol mono-(meth)acrylate, butoxy ethyl(meth)acrylate, butyl(meth)acrylate, cetyl(meth)acrylate, ethylene oxide-modified (hereinafter referred to as “EO”) cresol(meth)acrylate, dipropylene glycol(meth)acrylate, ethoxylated phenyl(meth)acrylate, ethyl(meth)acrylate, isoamyl(meth)acrylate, isobutyl(meth)acrylate, isooctyl(meth)acrylate, cyclohexyl(meth)acrylate, isobornyl(meth)acrylate, dicyclopentanyl(meth)acrylate, dicyclopentanyl oxyethyl(meth)acrylate, isomyristyl(meth)acrylate, lauryl(meth)acrylate, methoxy dipropylene glycol(meth)acrylate, methoxy tripropylene glycol(meth)acrylate, methoxy polyethylene glycol(meth)acrylate, methoxy triethylene glycol(meth)acrylate, methyl(meth)acrylate, neopentyl glycol benzoate(meth)acrylate, nonyl phenoxy polyethylene glycol(meth)acrylate, nonyl phenoxy polypropylene glycol(meth)acrylate, octyl(meth)acrylate, paracumyl phenoxy ethylene glycol(meth)acrylate, epichlorohydrin (hereinafter referred to as “ECH”) modified phenoxy acrylate, phenoxy ethyl(meth)acrylate, phenoxy diethylene glycol(meth)acrylate, phenoxy hexaethylene glycol(meth)acrylate, phenoxy tetraethylene glycol(meth)acrylate, polyethylene glycol(meth)acrylate, polyethylene glycol polypropylene glycol(meth)acrylate, polypropylene glycol(meth)acrylate, stearyl(meth)acrylate, EO-modified succinate(meth)acrylate, tert-butyl(meth)acrylate, tribromo phenyl(meth)acrylate, EO-modified tribromo phenyl(meth)acrylate, tridodecyl(meth)acrylate, p-isopropenyl phenol, styrene, α-methyl styrene, acrylonitrile, and the like.

Of these, a monofunctional (meth)acrylate having an aromatic structure and/or an alicyclic hydrocarbon structure is desirable, from the viewpoint of improving dry etching resistance. To give specific examples, benzyl(meth)acrylate, dicyclopentanyl(meth)acrylate, dicyclopentanyl oxyethyl(meth)acrylate, isobornyl(meth)acrylate, and adamantyl(meth)acrylate are desirable, and benzyl(meth)acrylate is especially desirable.

For the further polymerizable monomer, it is desirable to use a polyfunctional polymerizable unsaturated monomer having two ethylenic unsaturated bond-containing groups. Specific examples of a bifunctional polymerizable unsaturated monomer having two ethylenic unsaturated bond-containing groups which are desirable for use include: diethylene glycol monoethyl ether(meth)acrylate, dimethylol dicyclopentane di-(meth)acrylate, di-(meth)acrylated isocyanurate, 1,3-butylene glycol di-(meth)acrylate, 1,4-butane diol di-(meth)acrylate, EO-modified 1,6-hexane diol di-(meth)acrylate, ECH-modified 1,6-hexane diol di-(meth)acrylate, allyloxy polyethylene glycol acrylate, 1,9-nonane diol di-(meth)acrylate, EO-modified bisphenol A di-(meth)acrylate, PO-modified bisphenol A di-(meth)acrylate, modified bisphenol A di-(meth)acrylate, EO-modified bisphenol F di-(meth)acrylate, ECH-modified hexahydro phthalate diacrylate, neopentyl glycol hydroxy pivalate di-(meth)acrylate, neopentyl glycol di-(meth)acrylate, EO-modified neopentyl glycol diacrylate, propylene oxide (hereinafter referred to as “PO”) modified neopentyl glycol diacrylate, caprolactone-modified neopentyl glycol hydroxy pivalate ester, stearic acid-modified pentaerythritol di-(meth)acrylate, ECH-modified phthalic acid di-(meth)acrylate, poly(ethylene glycol-tetramethylene glycol)di-(meth)acrylate, poly(propylene glycol-tetramethylene glycol)di-(meth)acrylate, polyester (di)acrylate, polyethylene glycol di-(meth)acrylate, polypropylene glycol di-(meth)acrylate, ECH-modified propylene glycol di-(meth)acrylate, silicone di-(meth)acrylate, triethylene glycol di-(meth)acrylate, tetraethylene glycol di-(meth)acrylate, dimethylol tricyclodecane di-(meth)acrylate, neopentyl glycol-modified trimethylol propane di-(meth)acrylate, tripropylene glycol di-(meth)acrylate, EO-modified tripropylene glycol di-(meth)acrylate, triglycerol di-(meth)acrylate, dipropylene glycol di-(meth)acrylate, divinyl ethylene urea, divinyl propylene urea, and the like.

Of these, in the present invention, it is especially suitable to use: neopentyl glycol di-(meth)acrylate, 1,9-nonane diol di-(meth)acrylate, tripropylene glycol di-(meth)acrylate, tetraethylene glycol di-(meth)acrylate, neopentyl glycol hydroxy pivalate di-(meth)acrylate, polyethylene glycol di-(meth)acrylate, or the like.

Possible examples of a polyfunctional polymerizable unsaturated monomer having three or more ethylenic unsaturated bond-containing groups include: ECH-modified glycerol tri-(meth)acrylate, EO-modified glycerol tri-(meth)acrylate, PO-modified glycerol tri-(meth)acrylate, pentaerythritol triacrylate, EO-modified phosphoric acid triacrylate, trimethylol propane tri-(meth)acrylate, caprolactone-modified trimethylol propane tri-(meth)acrylate, EO-modified trimethylol propane tri-(meth)acrylate, PO-modified trimethylol propane tri-(meth)acrylate, tris-(acryloxy ethyl) isocyanurate, dipentaerythritol hexa-(meth)acrylate, caprolactone-modified dipentaerythritol hexa-(meth)acrylate, dipentaerythritol hydroxyl penta-(meth)acrylate, alkyl-modified dipentaerythritol penta-(meth)acrylate, dipentaerythritol poly-(meth)acrylate, alkyl-modified dipentaerythritol tri-(meth)acrylate, di-trimethylol propane tetra-(meth)acrylate, pentaerythritol ethoxy tetra-(meth)acrylate, pentaerythritol tetra-(meth)acrylate, and the like.

Of these, in the present invention, it is especially suitable to use: EO-modified glycerol tri-(meth)acrylate, PO-modified glycerol tri-(meth)acrylate, trimethylol propane tri-(meth)acrylate, EO-modified trimethylol propane tri-(meth)acrylate, PO-modified trimethylol propane tri-(meth)acrylate, dipentaerythritol hexa-(meth)acrylate, pentaerythritol ethoxy tetra-(meth)acrylate, pentaerythritol tetra-(meth)acrylate, and the like.

Possible examples of a compound having an oxirane ring (epoxy compound) are: for instance, polyglycidyl esters of a polybasic acid, polyglycidyl ethers of a polyvalent alcohol, polyglycidyl ethers of polyoxyalkylene glycol, polyglycidyl ethers of an aromatic polyol, hydrogenated compounds of polyglycidyl ethers of an aromatic polyol, urethane polyepoxy compounds, epoxidated polybutadienes, and the like. These compounds can be used independently, or as a combination of two or more types.

Specific examples of a compound having an oxirane ring (epoxy compound) include: for instance, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butane diol diglycidyl ether, 1,6-hexane diol diglycidyl ether, glycerine triglycidyl ether, trimethylol propane triglycidyl ether, polyethylene glycol diglycidyl ether, or a polypropylene glycol diglycidyl ether; or a polyglycidyl ether of polyether polyol obtained by adding one or two or more types of alkylene oxide to an aliphatic polyfunctional alcohol, such as ethylene glycol, propylene glycol, glycerine, or the like; diglycidyl esters of an aliphatic long-chain dibasic acid; monoglycidyl ethers of an aliphatic higher alcohol; phenol, cresol, butyl phenol, or a monoglycidyl ether of polyether alcohol obtained by adding alkylene oxide to one of these; or a glycidyl ester of a higher fatty acid, or the like.

Of these, in the present invention, it is desirable to use: bisphenol A diglycidyl ether, bisphenol F diglycidyl ether, hydrogenated bisphenol A diglycidyl ether, hydrogenated bisphenol F diglycidyl ether, 1,4-butane diol diglycidyl ether, 1,6-hexane diol diglycidyl ether, glycerine triglycidyl ether, trimethylol propane triglycidyl ether, neopentyl glycol diglycidyl ether, polyethylene glycol diglycidyl ether or polypropylene glycol diglycidyl ether.

Commercial products which can be used suitably as a compound containing a glycidyl group are, for instance: UVR-6216 (manufactured by Union Carbide); Glycidol, AOEX 24 and Cyclomer A200 (manufactured by Daicel Chemical Industries); Eipcoat 828, Epicoat 812, Epicoat 1031, Epicoat 872 and Epicoat CT 508 (manufactured by Yuka Shell Co., Ltd.); KRM-2400, KRM-2410, KRM-2408, KRM2490, KRM-2720 and KRM-2750 (manufactured by Asahi Denka Kogyo), and the like. These can be used independently or as a combination of two or more types.

There are no restrictions on the method of fabricating these compounds containing an oxirane ring, and they can be synthesized with reference, for example, to Patent Literatures 4, 5 and 6 (PTLs 4-6).

The further polymerizable monomer used in the present invention can make combined use of a vinyl ether compound. A commonly known vinyl ether compound can be selected appropriately, for example: 2-ethyl hexyl vinyl ether, butane diol-1,4-divinyl ether, diethylene glycol monovinyl ether, diethylene glycol monovinyl ether, ethylene glycol divinyl ether, triethylene glycol divinyl ether, 1,2-propane diol divinyl ether, 1,3-propane diol divinyl ether, 1,3-butane diol divinyl ether, 1,4-butane diol divinyl ether, tetramethylene glycol divinyl ether, neopentyl glycol divinyl ether, trimethylol propane trivinyl ether, trimethylol ethane trivinyl ether, hexane diol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethyelene vinyl ether, triethylene glycol diethyelene vinyl ether, ethylene glycol dipropylene vinyl ether, triethylene glycol diethyelene vinyl ether, trimethylol propane triethylene vinyl ether, trimethylol propane diethylene vinyl ether, pentaerythritol diethylene vinyl ether, pentaerythritol triethylene vinyl ether, pentaerythritol tetraethylene vinyl ether, 1,1,1-tris[4-(2-vinyloxy ethoxy) phenyl]ethane, bisphenol A divinyloxy ethyl ether, or the like.

These vinyl ether compounds can be synthesized, for example, by reaction of a polyvalent alcohol or a polyvalent phenol with acetylene, or by reaction of polyvalent alcohol or polyvalent phenol with a halogenated alkyl vinyl ether, and these can be used independently or as a combination of two or more types.

Furthermore, it is also possible to use a styrene derivative for the further polymerizable monomer. Possible examples of a styrene derivative are: styrene, p-methyl styrene, p-methoxy styrene, β-methyl styrene, p-methyl-β-methyl styrene, α-methyl styrene, p-methoxy-β-methyl styrene, p-hydroxy styrene, and the like.

Furthermore, with the object of improving separation from the mold and application characteristics, it is also possible to combine use of a compound having a fluorine atom, such as: trifler ethyl(meth)acrylate, pentafluoro ethyl(meth)acrylate, (perfluoro butyl)ethyl(meth)acrylate, perfluoro butyl-hydroxy propyl(meth)acrylate, (perfluoro hexyl)ethyl(meth)acrylate, octafluoro pentyl(meth)acrylate, perfluoro octyl ethyl(meth)acrylate, tetrafluoro propyl(meth)acrylate, or the like.

For the further polymerizable monomer, it is also possible to use propenyl ether and butenyl ether. For the propenyl ether or the butenyl ether, it is suitable to use, for instance: 1-dodecyl-1-propenyl ether, 1-dodecyl-1-butenyl ether, 1-butenoxy methyl-2-norbornene, 1-4-di(1-butenoxy)butane, 1,10-di(1-butenoxy) decane, 1,4-di(1-butenoxy methyl)cyclohexane, diethylene glycol di(1-butenyl)ether, 1,2,3,-tri(1-butenoxy)propane, propenyl ether propylene carbonate, or the like.

<Fluorine-Containing Surfactant>

In the imprint system described in the present embodiment, the fluorine-containing surfactant forms one part of the resist pattern, and therefore desirably has good pattern forming properties, and good mold separation properties after curing and good etching resistance.

The content ratio of the fluorine-containing surfactant in the resist composition is, for example, not less than 0.001 wt % and not more than 5 wt %, desirably not less than 0.002 wt % and not more than 4 wt %, and more desirably, not less than 0.005 wt % and not more than 3 wt %. If using two or more types of surfactants, the total amount thereof should be in the ranges stated above. If the amount of surfactant in the resin composition is not less than 0.001 wt % and not more than 5 wt %, then good effects in terms of the uniformity of application are obtained, and issues such as worsening of the mold transfer properties due to an excessive amount of surfactant, or deterioration of the etching compatibility in the etching step after imprint are not liable to occur.

<Polymerization Initiator I>

There are no particular restrictions on the polymerization initiator I, provided that it generates an active species for starting polymerization of the polymerizable compound included in the resist composition upon activation by the light L1 used to cure the resist composition. A radical polymerization initiator is desirable as the polymerization initiator I. Furthermore, in the present invention, it is also possible to employ a plurality of types of the polymerization initiator I.

For the polymerization initiator I, an acyl phosphine oxide compound or an oxime ester compound are desirable from the viewpoint of curing sensitivity and absorption characteristics; for example, it is desirable to use the compound described in paragraph 0091 of the description of Patent Literature 7 (PTL 7), for example.

The content of the polymerization initiator I in the whole composition apart from the solvent is, for example, not less than 0.01 wt % and not more than 15 wt %, desirably, not less than 0.1 wt % and not more than 12 wt %, and more desirably, not less than 0.2 wt % and not more than 7 wt %. If using two or more types of photo-polymerization initiator, the total amount thereof should be in the ranges stated above.

It is desirable if the content of the photo-polymerization initiator is not less than 0.01 wt %, since this tends to lead to improvement in the sensitivity (fast curing properties), image resolution, line edge roughness and applied film strength. On the other hand, it is desirable if the content of the photo-polymerization initiator is not more than 15 wt %, since this tends to lead to improvement in the light transmissivity, coloring properties and handling properties, and the like.

Hitherto, in compositions for inkjet use containing dye and/or pigment, and compositions for liquid crystal display color filters, various investigation has been made into a desirable added amount of the photo-polymerization initiator, but there have been no reports of the desirable added amount of photo-polymerization initiator in a curable composition for photo imprint, or the like. In other words, in a system containing dye and/or pigment, the initiator can act as a radical trapping agent, and has an effect on the photo-polymerization properties and the sensitivity. In view of this point, in these applications, the added amount of the photo-polymerization initiator is optimized. On the other hand, in a resist composition, dye and/or pigment are not essential components, and the optimal range of the photo-polymerization initiator can be different from that in the field of, for instance, compositions for inkjet use or compositions for liquid crystal display color filters.

For the radical photo-polymerization initiator included in a resist which is employed in the imprint system described in the present embodiment, an acyl phosphine compound and an oxime ester compound are desirable from the viewpoint of curing sensitivity and absorption characteristics. The radical photo-polymerization initiator used in the present invention can use a commercially available initiator, for example. For instance, it is suitable to use the initiators described in paragraph 0091 of the description of Patent Literature 7, for example.

The light L1 includes light having wavelengths in the regions of ultraviolet light, near-ultraviolet light, far-ultraviolet light, visible light and infrared light, as well as electromagnetic waves and radiation. This radiation includes, for example, microwaves, electron beams, EUV, and X rays. It is also possible to use laser light from a 248 nm excimer laser, a 193 nm excimer laser, a 172 nm excimer laser, or the like. These lights can be monochromatic light (single-wavelength light) which has been passed through an optical filter, or light of a plurality of different wavelengths (complex light). The exposure light can be superimposed exposure light, and it is also possible to expose the whole surface after forming a pattern, with a view to improving the film strength and the etching resistance.

For the photo-polymerization initiator I, it is necessary to select a suitable initiator for the wavelength of the light source used, but an initiator which does not generate gas during pressurization of the mold or exposure is desirable. The production of gas causes soiling of the mold, leading in turn to problems such as the need for frequent cleaning of the mold and deformation of the resist composition inside the mold, which degrades the accuracy of the transfer pattern, and so on.

In the resist composition, desirably, the polymerizable monomer which is included is a radical polymerizable monomer, and the photo-polymerization initiator I is a radical polymerization initiator which generates radicals upon the irradiation of light.

<Other Components>

As stated previously, the resin composition used in the imprint system described in the present embodiment can include, in addition to the polymerizable compound, the fluorine-containing surfactant and the photo-polymerization initiator I described above, and other components such as surfactants, anti-oxidants, solvents, polymer components, and the like, for various purposes, within a range that does not affect the beneficial effects of the present invention. A summary of these other components is given below.

<Anti-Oxidant>

In the resist composition, it is possible to include a commonly known anti-oxidant. The content ratio of the anti-oxidant with respect to the polymerizable monomer is, for example, not less than 0.01 wt % and not more than 10 wt %, and desirably, not less than 0.2 wt % and not more than 5 wt %. If using an anti-oxidant of two or more types, the total amount thereof should be in the ranges stated above.

The anti-oxidant suppresses color fading due to heat and light irradiation, and color fading due to various oxidizing gases such as ozone, active oxygen, NO_{X}, SO_{X} (where X is an integer), and the like. In particular, in the present invention, by adding an anti-oxidant, an advantage is obtained in that coloration of the cured film is prevented and decline in the film thickness due to decomposition can be reduced. Possible examples of an anti-oxidant of this kind can include: a hydrazide, a hindered amine anti-oxidant, a nitrogen-containing heterocyclic mercapto compound, a thio ether anti-oxidant, a hindered phenol anti-oxidant, an ascorbic acid, zinc sulfate, a thiocyanate salt, a thio-urea derivative, a saccharide, a nitrous acid salt, a sulfurous acid salt, a thiosulfuric acid salt, a hydroxyl amine derivative, or the like. Of these, a hindered phenol anti-oxidant and a thio ether anti-oxidant are especially desirable, from the viewpoint of coloration of the cured film and decline in the film thickness.

Possible examples of commercially available anti-oxidants include: Irganox 1010, 1035, 1076, 1222 (manufactured by Ciba Geigy Co., Ltd.), Antigene P, 3C, FR, Sumilizer S, Sumilizer GA80 (manufactured by Sumitomo Chemical Co., Ltd.), Adeka Stab A070, A080, A0503 (manufactured by Adeka Corp.), and so on. These can be used independently or in combination with each other.

<Polymerization Inhibitor>

Desirably, the resist composition also includes a small amount of polymerization inhibitor. By combining a suitable amount of a polymerization inhibitor, in other words, a polymerization inhibitor content with respect to the whole amount of polymerizable monomer of not less than 0.001 wt % and not more than 1 wt %, desirably not less than 0.005 wt % and not more than 0.5 wt %, and more desirably not less than 0.008 wt % and not more than 0.05 wt %, then it is possible to suppress change in viscosity over time, at the same time as maintaining high curing sensitivity.

<Solvent>

The resist composition can include various solvents, according to requirements. A desirable solvent is one having a boiling point of 80° C. to 280° C. at normal pressure. It is possible to use any type of solvent, provided that the solvent is capable of dissolving the composition, but desirably, the solvent is one having at least one of an ester structure, a ketone structure, a hydroxyl group, and an ether structure. More specifically, desirable solvents are an independent solvent or mixed solvent selected from: propylene glycol monomethyl ether acetate, cyclohexanone, 2-heptanone, gamma-butyrolactone, propylene glycol monomethyl ether and ethyl lactate, and a solvent containing propylene glycol monomethyl ether acetate is most desirable from the viewpoint of uniformity of application.

The content of the solvent in the resist composition is adjusted optimally in accordance with the viscosity of the components other than the solvent, the application characteristics and the target film thickness, but the content of solvent is desirably 0 to 99 wt % in the whole composition, and more desirably, 0 to 97 wt %, from the viewpoint of improving the application characteristics. In particular, when forming a pattern having a film thickness of not more than 500 nm, the solvent content is desirably not less than 20 wt % and not more than 99 wt %, more desirably, not less than 40 wt % and not more than 99 wt % and especially desirably, not less than 70 wt % and not more than 98 wt %.

<Polymer Components>

In order to further raise the cross-linking density, in the resist composition, it is possible to combine a polyfunctional oligomer having a greater molecular weight than the other polyfunctional polymerizable monomers described above, within a range which achieves the object of the present invention. Possible examples of a polyfunctional oligomer having photo-radical polymerization properties include various acrylate oligomers, such as polyester acrylate, urethane acrylate, polyether acrylate, epoxy acrylate, and the like. The added amount of the oligomer component with respect to the components of the composition apart from the solvent is desirably 0 to 30 wt %, more desirably, 0 to 20 wt %, even more desirably, 0 to 10 wt % and most desirably, 0 to 5 wt %.

The resist composition can also include a polymer component, with a view to improving the dry etching resistance, the imprint compatibility, and the curing properties. A polymer having a polymerizable functional group in a side chain is desirable as this polymer component. The weight-average molecular weight of the polymer component is desirably not less than 2000 and not more than 100000, and more desirably not less than 5000 and not more than 50000, from the viewpoint of compatibility with the polymerizable monomer.

The added amount of the polymer component with respect to the components of the composition apart from the solvent is desirably 0 to 30 wt %, more desirably, 0 to 20 wt %, even more desirably, 0 to 10 wt % and most desirably, not more than 2 wt %. From the viewpoint of the pattern forming properties, desirably, the content of polymer component having a molecular weight not less than 2000 in the resin composition is not more than 30 wt %, with respect to the components apart the solvent. It is desirable for the resin component to be as little as possible, and preferably, no resin component is included apart from the surfactant and a very small amount of additive.

Apart from the components described above, according to requirements, it is also possible to add the following to the resist composition: a mold separating agent, a silane coupling agent, an ultraviolet light absorber, a light stabilizer, an anti-aging agent, a plasticizer, an adhesion promoter, a thermal polymerization initiator, a coloring agent, elastomer granules, a photoacid profilerating agent, a photobase generating agent, a base compound, a fluidity adjuster, an anti-foaming agent, a dispersant, and the like.

The resist composition can be prepared by combining the respective components described above. Furthermore, it is also possible to prepare the resist composition by combining the respective components and then passing through a filter having a pore diameter of 0.003 μm to 5.0 μm, for instance. The mixing and dissolving of the curable composition for photo imprint is generally carried out in a range of 0° C. to 100° C. Filtering can be carried out in multiple stages and can be repeated multiple times. Moreover, it is also possible to refilter the liquid which has already been filtered. The filter used for filtering can employ polyethylene resin, polypropylene resin, fluororesin, nylon resin, or the like, although there are no particular restrictions on the material of the filter.

In the resist composition, the viscosity at 25° C. of the components apart from the solvent is desirably not less than 1 mPa·s and not more than 100 mPa·s. The viscosity is more desirably not less than 3 mPa·s and not more than 50 mPa·s, and even more desirably, not less than 5 mPa·s and not more than 30 mPa·s. By setting the viscosity to a suitable range, the rectangular shape properties of the pattern are improved, and it is possible to further suppress remaining film.

The nanoimprint system, apparatus and method according to the present invention have been described in detail above, but the present invention is not limited to the aforementioned examples, and it is of course possible for improvements or modifications of various kinds to be implemented, within a range which does not deviate from the essence of the present invention.

### EXPLANATION OF REFERENCE NUMERALS

10, 102: substrate; 12, 110: inkjet head; 14: liquid droplet; 16, 112: mold; 18: light-curable resin film; 20, 22, 24, 28: projecting section; 26: recess section; 100: nanoimprint system; 104: resist application unit; 106: pattern transfer unit; 108: conveyance unit; 114: ultraviolet light irradiation device; 120, 120A, 120B, 120C: nozzle; 123, 153, 154, 155: piezoelectric element; 121: side wall; 122, 122A, 122B, 122C: liquid chamber; 172: system controller; 180: droplet ejection controller; 184: head driver; 192: sensor; 194: counter; 404: waveform generation unit; 405: display data generation unit

### CITATION LIST

### Patent Literatures

PTL 1: International Publication No. WO 2005/120834
PTL 2: Japanese Patent Application Publication No. 2009-088376
PTL 3: Japanese Patent Application Publication No. 2009-218550
PTL 4: Japanese Patent Application Publication No. 11-100378
PTL 5: Japanese Patent Application Publication No. 04-036263
PTL 6: Japanese Patent Application Publication No. 04-069360
PTL 7: Japanese Patent Application Publication No. 2008-105414

What is claimed is:

1. A liquid application device, comprising:
a liquid ejection head including: a plurality of nozzles configured to perform ejection of droplets of liquid having functional properties toward a substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles;
a relative movement device which is configured to cause relative movement of the substrate and the liquid ejection head; and
a droplet ejection control device which is configured to group the nozzles in the liquid ejection head into groups of not less than three in such a manner that adjacent nozzles belong to different groups, and is configured to control operation of the piezoelectric elements in such a manner that the droplet ejection is performed at a same timing only through the nozzles belonging to a same group so as to deposit the liquid discretely onto the substrate.

2. The liquid application device as defined in claim 1, wherein the droplet ejection control device groups the nozzles into the groups the number of which is an integral multiple of three.

3. The liquid application device as defined in claim 1, further comprising a drive voltage generation device which is configured to generate, for each of the groups, a drive voltage to be applied to the piezoelectric elements belonging to each group.

4. The liquid application device as defined in claim 1, wherein the droplet ejection control device controls the operation of the piezoelectric elements so as to operate the piezoelectric elements on both sides of one of the liquid chambers connected to one of the nozzles belonging to one of the groups that is designated to perform the droplet ejection and so as not to operate at least one of the piezoelectric elements on both sides of one of the liquid chambers connected to one of the nozzles belonging to one of the groups that is not designated to perform the droplet ejection.

5. The liquid application device as defined in claim 1, wherein the liquid ejection head has a structure in which the nozzles are arranged over an entire length of the substrate in a direction perpendicular to a relative movement direction of the relative movement device, and has a structure in which the nozzles belonging to the same group are arranged in the direction perpendicular to the relative movement direction of the relative movement device, and the nozzles belonging to different groups are arranged at prescribed intervals apart along the relative movement direction of the relative movement device.

6. The liquid application device as defined in claim 1, wherein each of the side walls of the liquid chambers has a structure in which two piezoelectric elements are joined in a direction perpendicular to an arrangement direction of the liquid chambers, and the two piezoelectric elements have polarization directions opposite to each other along the direction perpendicular to the arrangement direction of the liquid chambers.

7. The liquid application device as defined in claim 1, further comprising:
a head turning device which is configured to turn the liquid ejection head within a plane parallel to a surface of the substrate on which the liquid having the functional properties is deposited; and
a droplet deposition density changing device which is configured to change a droplet deposition density in a direction substantially perpendicular to a relative movement direction of the relative movement device by turning the liquid ejection head with the head turning device.

8. The liquid application device as defined in claim 1, wherein in one relative movement action of the substrate and the liquid ejection head, the droplet ejection control device causes only the piezoelectric elements corresponding to the nozzles belonging to one of the groups to operate in such a manner that the droplet ejection is performed only by the nozzles belonging to the one of the groups.

9. The liquid application device as defined in claim 1, wherein the droplet ejection control device causes the piezoelectric elements to operate in such a manner that a droplet deposition pitch in a direction substantially parallel to a relative movement direction of the relative movement device is altered within a range less than a minimum droplet deposition pitch.

10. The liquid application device as defined in claim 1, wherein the droplet ejection control device delays a timing of operation of the piezoelectric elements by adding a delay time which is less than a minimum droplet ejection period.

11. The liquid application device as defined in claim 1, wherein the droplet ejection control device changes a waveform of the drive voltage applied to the piezoelectric elements, for each of the groups.

12. The liquid application device as defined in claim 1, wherein the droplet ejection control device changes a maximum voltage of the drive voltage applied to the piezoelectric elements, for each of the groups.

13. The liquid application device as defined in claim 1, wherein the droplet ejection control device changes a width of a maximum amplitude portion of the drive voltage applied to the piezoelectric elements, for each of the groups.

14. The liquid application device as defined in claim 1, further comprising:
a droplet ejection action counting device which is configured to count a number of droplet ejection actions for each of the groups; and
a droplet ejection action count storage device which is configured to store the counted number of droplet ejection actions for each of the groups.

15. The liquid application device as defined in claim 14, further comprising:
a selection device which is configured to select one of the groups of the nozzles to be designated to perform the droplet ejection in accordance with results stored in the droplet ejection action count storage device,
wherein the droplet ejection control device controls the operation of the piezoelectric elements in accordance with selection results of the selection device.

16. The liquid application device as defined in claim 1, wherein:
the liquid ejection head has a structure in which the nozzles each have substantially square planar shapes, and are arranged such that directions of edges of the square planar shapes are substantially parallel to an arrangement direction of the nozzles; and
the liquid application device further comprises an observation device which is configured to observe the ejected droplets in a direction at substantially 45° with respect to a direction of a diagonal line of each of the nozzles.

17. A liquid application method of discretely depositing liquid having functional properties onto a substrate by: relatively moving the substrate and a liquid ejection head including: a plurality of nozzles configured to perform ejection of droplets of the liquid toward the substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles; and operating the piezoelectric elements at a prescribed droplet ejection period,
wherein the nozzles are grouped into groups of not less than three in such a manner that adjacent nozzles belong to different groups, and operation of the piezoelectric elements is controlled in such a manner that the droplet ejection is performed at a same timing only through the nozzles belonging to a same group so as to deposit the liquid discretely onto the substrate.

18. A nanoimprint system, comprising:
a liquid ejection head including: a plurality of nozzles configured to perform ejection of droplets of liquid having functional properties toward a substrate; and a plurality of liquid chambers which are connected respectively to the nozzles, the liquid chambers being defined by side walls, at least respective parts of the side walls being constituted of piezoelectric elements, the liquid ejection head being configured to cause shear deformation of the piezoelectric elements to eject the droplets of the liquid in the liquid chamber through the nozzles;
a relative movement device which is configured to cause relative movement of the substrate and the liquid ejection head;
a droplet ejection control device which is configured to group the nozzles in the liquid ejection head into groups of not less than three in such a manner that adjacent nozzles belong to different groups, and is configured to control operation of the piezoelectric elements in such a manner that the droplet ejection is performed at a same timing only through the nozzles belonging to a same group so as to deposit the liquid discretely onto the substrate; and
a transfer device which is configured to transfer a projection-recess pattern formed in a mold.

19. The nanoimprint system as defined in claim 18, wherein the transfer device includes:
a pressing device which is configured to press a surface of the mold in which the projection-recess pattern is formed, against a surface of the substrate on which the liquid has been applied;
a curing device which is configured to cure the liquid located between the mold and the substrate; and
a separating device which is configured to separate the mold and the substrate.

20. The nanoimprint system as defined in claim 18, further comprising:
a separating device which is configured to separate the mold from the substrate, after transfer by the transfer device;
a pattern forming device which is configured to form, on the substrate, a pattern corresponding to the projection-recess pattern of the mold, using a film which is formed of cured liquid and to which the projection-recess pattern has been transferred, as a mask; and
a removal device which removes the film.
